(19) United States
(12) Patent Application Publication
(10) Pub. No.: US 2008/0319754 A1
(43) Pub. Date: Dec. 25, 2008

(54) Text-to-speech apparatus

(75) Inventors: Rika Nishiike, Kawasaki (JP); Hitoshi Sasaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/213,115

(22) Filed: Jun. 13, 2008

(30) Foreign Application Priority Data
Jun. 25, 2007 (JP) 2007-167019

(51) Int. Cl. G10L 13/06; G10L 13/08

(52) U.S. Cl. 704/260; 704/267; 704/E13.009; 704/E13.011

(57) ABSTRACT

According to an aspect of an embodiment, an apparatus for converting text data into sound signal, comprises: a phoneme determiner for determining phoneme data corresponding to a plurality of phonemes and pause data corresponding to a plurality of pauses to be inserted among a series of phonemes in the text data to be converted into sound signal; a phoneme length adjuster for modifying the phoneme data and the pause data by determining lengths of the phonemes, respectively in accordance with a speed of the sound signal and selectively adjusting, the length of at least one of the phonemes which is a fricative in the text data so that the at least one of the fricative phonemes is relatively extended timewise as compared to other phonemes; and an output unit for outputting sound signal on the basis of the adjusted phoneme data and pause data by the phoneme length adjuster.

### BACKGROUND OF THE INVENTION

1. Field of the Invention

The present invention relates to apparatuses, programs, and methods for speech reading for converting character data including phonetic characters, such as a document, to speech and outputting the speech, and in particular, relates to an apparatus, a program, and a method for speech reading for controlling the phoneme length in response to the speech rate, especially, in speech reading at a high rate, selecting specific phonemes and the like and enabling the extension or shortening of the specific phonemes and the like.

2. Description of the Related Art

Techniques for what is called speech reading in which character data including phonetic characters is analyzed, speech is synthesized from the character data by speech synthesis, and the character data is output as the speech are known. In portable terminals such as cellular phones, a speech synthesis function of reading free texts such as mail has started to be widely used. Moreover, in personal computers (PCs), software called a screen reader has started to be widely used. When the content of a text is understood by speech, the length of a phoneme that represents, for example, a vowel, a fricative, or a pause that acts on the sense of hearing is an important factor in improving the recognizability.

Regarding such speech reading, Japanese Laid-open Patent Publication No. 6-149283 (for example, Abstract and FIG. 1) discloses speech synthesis in which, when the speech rate is less than a predetermined value, the mora length is set to the minimum value, and a short frame period corresponding to the speech rate is set so that the speech rate is higher than the normal rate on the basis of the speech rate; and when the speech rate is equal to or more than the predetermined value, a long mora length corresponding to the speech rate is set, and the length of a frame period is set to the maximum value so that the speech rate is lower than the normal rate on the basis of the speech rate.

Here, it is assumed that, when the speech rate can be set flexibly, the length of each phoneme is set so as to vary inversely as the speech rate. For example, when the speech rate is doubled, the phoneme length is reduced by half, and when the speech rate is reduced by half, the phoneme length is doubled. In an arrangement in which the relationship between the speech rate and the phoneme length is simplified, i.e., the phoneme length varies inversely as the speech rate, even when speech is natural (when it is easy to hear the speech) at the normal speech rate, in speech reading at a high rate and a low rate, it may be difficult to hear the speech, and the speech may be unnatural. Thus, the recognizability may decrease.

Japanese Laid-open Patent Publication No. 6-149283 does not disclose or suggest such problems and any arrangement for providing solutions.

### SUMMARY

According to an aspect of an embodiment, an apparatus for converting text data into sound signal, comprises: a phoneme determiner for determining phoneme data corresponding to a plurality of phonemes and pause data corresponding to a plurality of pauses to be inserted among a series of phonemes in the text data to be converted into sound signal; a phoneme length adjuster for modifying the phoneme data and the pause data by determining lengths of the phonemes, respectively in accordance with a speed of the sound signal and selectively adjusting the length of at least one of the phonemes which is a fricative in the text data so that the at least one of the fricative phonemes is relatively extended timewise as compared to other phonemes; and an output unit for outputting sound signal on the basis of the adjusted phoneme data and pause data by the phoneme length adjuster.

### BRIEF DESCRIPTION OF THE DRAWINGS

FIG. 1 is a block diagram showing exemplary components of a speech reading apparatus according to a first embodiment;

FIG. 2 is a block diagram showing exemplary components of a phoneme length control unit in the speech reading apparatus;

FIG. 3 is a block diagram showing an exemplary portable terminal in which the speech reading apparatus is incorporated;

FIG. 4 shows an exemplary configuration of the portable terminal;

FIG. 5 shows an exemplary screen display;

FIG. 6 is a flowchart showing exemplary procedure for controlling the phoneme length according to the first embodiment;

FIG. 7 is a flowchart showing exemplary procedure for controlling the phoneme length according to a second embodiment;

FIG. 8 is a flowchart showing exemplary procedure for controlling the phoneme length according to a third embodiment;

FIG. 9 is a block diagram showing the phoneme length control unit according to a fourth embodiment;

FIG. 10 is a flowchart showing exemplary procedure for controlling the phoneme length according to the fourth embodiment;

FIG. 11 is a block diagram showing the phoneme length control unit according to a fifth embodiment;

FIG. 12 is a flowchart showing exemplary procedure for controlling the phoneme length according to the fifth embodiment;

FIG. 13 is a flowchart showing exemplary procedure for controlling the phoneme length according to a sixth embodiment;

FIG. 14 is a flowchart showing exemplary procedure for controlling the phoneme length according to a seventh embodiment;

FIG. 15 is a flowchart showing exemplary procedure for controlling the phoneme length according to an eighth embodiment;

FIG. 16 is a block diagram showing a parameter generating unit that includes a speech rate adjusting unit;

FIG. 17 is a flowchart showing exemplary procedure for controlling the phoneme length;

FIG. 18 shows the result of language processing;

FIG. 19 shows examples of generated phoneme lengths;

FIG. 20 shows examples of generated phoneme lengths;

FIGS. 21a, 21b, and 21c, respectively, show synthesized speech waveforms;

FIGS. 22a, 22b, respectively, show synthesized speech waveforms;

FIGS. 23a, 23b, respectively, show synthesized speech waveforms;

FIGS. 24a, 24b, respectively, show synthesized speech waveforms; and

FIGS. 25a, 25b, respectively, show synthesized speech waveforms.

### DESCRIPTION OF THE PREFERRED EMBODIMENTS

### First Embodiment

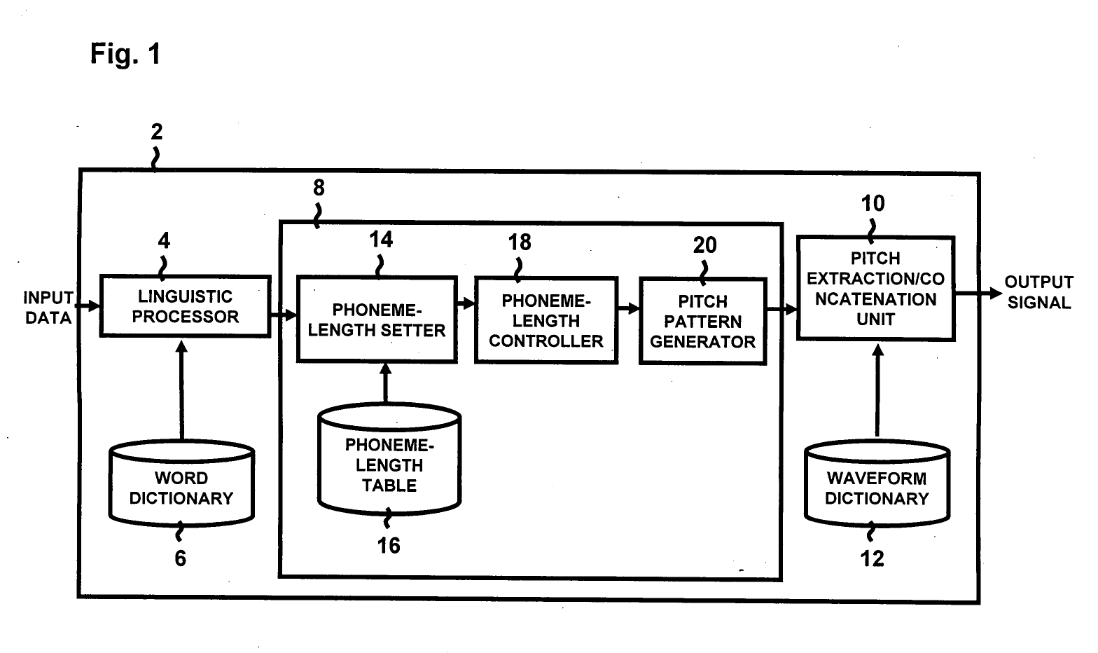

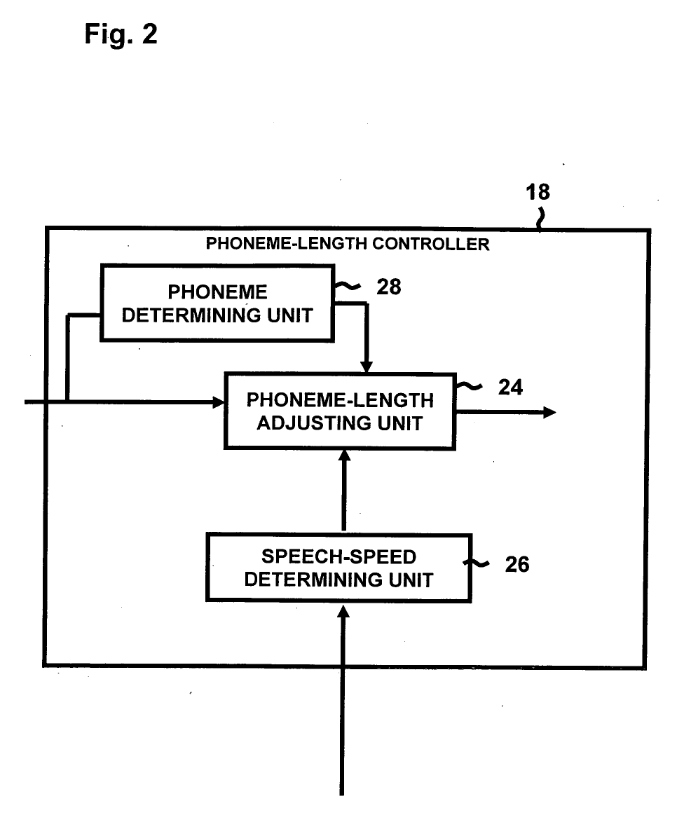

Regarding a first embodiment of the present invention, FIGS. 1 and 2 are referred to. FIG. 1 is a block diagram showing exemplary components of a speech reading apparatus 2. FIG. 2 is a block diagram showing exemplary components of a phoneme length control unit 18 in the speech reading apparatus 2.

The speech reading apparatus (speech read-aloud device, text to speech reading apparatus) 2 includes a computer. The speech reading apparatus 2 includes, for example, a speech synthesizer that converts character data including fricatives and pauses, such as a text (in the case of Japanese, a text including a mixture of Chinese characters and Japanese kana characters), to speech and reads the speech. The speech reading apparatus 2 improves the listenability of output speech obtained from character data by controlling the phoneme length of each fricative in the character data in response to the speech rate so as to improve the recognizability of synthesized speech (reading output). In this case, character data is subjected to speech reading and includes strings of phonetic characters including fricatives and pauses. A phonetic character or a string of phonetic characters is interlanguage that includes phonetic transcriptions (readings) with prosodic symbols used in speech synthesis. Fricatives are consonants that are sounded when breath passes through a narrow space formed by a voice organ in a mouth cavity and include, for example, “f”, “v”, “S”, and “z”. Pauses are silent intervals, such as intervals that are not converted to speech (except breaks just before plosives or Japanese sokuon). A Japanese sokuon is called a geminate consonant or double consonant in English. For example, in a Japanese sentence “so tsugyoushi te, shinyou kin koni . . . ”, a comma “,” that is a silent interval intervenes between “so tsugyoushi te” and “shinyou kin koni” and is an exemplary pause. Japanese sentence “so tsugyoshi te, shinyou kin koni . . . ” means “after (he) graduated from (high school), (he has worked) at a bank . . . ”. In other words, “so tsugyoshi te” means “after graduation” and “shinyou kin koni” means “at a bank”. In this case, a breath group is a unit in which a human utters in one breath, and an aforementioned pause intervenes in a breathing between breath groups.

To implement such a function, the speech reading apparatus 2 includes a language processing unit (linguistic processor) 4, a word dictionary 6, a parameter generating unit (parameter generator) 8, a pitch extracting/overlapping unit (pitch extracting/overlapping unit) 10, and a waveform dictionary 12, as shown in FIG. 1.

The language processing unit 4 is language processing means in which a text including a mixture of Chinese characters and Japanese kana characters is input, words in the text are analyzed with reference to the word dictionary 6, readings, accents, and intonations are determined, and a string of phonetic characters (interlanguage) is output. The types (for example, parts of speech), readings, positions of accents, and the like of words are stored in the word dictionary 6.

In physical terms, accents and intonations relate closely to the pattern of temporal variations in the pitch frequency. Specifically, the pitch frequency is high at the position of an accent and is high when the intonation rises. Thus, the language processing unit 4 divides the input text into aforementioned breath groups on the basis of, for example, punctuations and clauses extracted through the word analysis in the input text.

The parameter generating unit 8 is parameter generating means for setting, for example, the duration of each phoneme, the duration of each pause, and the pitch frequency pattern. The parameter generating unit 8 controls the phoneme length in response to the speech rate.

The parameter generating unit 8 includes a phoneme length setting unit (phoneme-length setter) 14, a phoneme length table 16, the phoneme length control unit (phoneme-length controller) 18, and a pitch pattern generating unit (pitch pattern generator) 20.

At the level of the string of phonetic characters generated in the language processing unit 4, it is determined which phonemes are subjected to speech synthesis. The phoneme length setting unit 14 is means for setting a phoneme length for each phoneme and sets a phoneme length at the normal speech rate. The phoneme length table 16 is means for storing phoneme lengths at the normal speech rate, each in response to a corresponding phoneme and preceding and following phonemes. In exemplary setting of a phoneme length, phoneme lengths (values extracted from a database) at the normal speech rate, each in response to a corresponding phoneme and preceding and following phonemes, are stored in the phoneme length table 16 in advance, and a phoneme length is set with reference to the values of the phoneme lengths. The phoneme length may be corrected using another parameter element.

The phoneme length control unit 18 is phoneme length control means for controlling the phoneme length at the normal speech rate set in the phoneme length setting unit 14 in response to the speech rate. The speech rate is supplied to the phoneme length control unit 18 as control information from, for example, means (not shown) for adjusting the speech rate (for example, user setting).

The phoneme length control unit (phoneme-length controller) 18 includes a phoneme length adjusting unit (phoneme-length adjusting unit) 24, a speech rate determining unit (speech-speed determining unit, speaking rate determining unit) 26, and a phoneme determining unit 28, as shown in FIG. 2. The phoneme length adjusting unit 24 adjusts the length of each phoneme and the length of each pause upon receiving the results of determination from the speech rate determining unit 26 and the phoneme determining unit 28. The speech rate determining unit 26 determines which of the normal rate, the high rate, and the low rate the input speech rate is and outputs the result of determination to the phoneme length adjusting unit 24. In this case, the result of determination output from the speech rate determining unit 26 includes an output that indicates the normal rate, the high rate, or the low rate and an output that indicates the level of the speech rate. The phoneme determining unit 28 determines, for example, phonemes and pauses with the phoneme length set in the phoneme length setting unit 14 (FIG. 1) and outputs the result of determination to the phoneme length adjusting unit 24.

In the phoneme length control unit 18 like this, for example, the phoneme length is set so as to vary inversely as the speech rate. Specifically, assuming that the normal speech rate is seven moras per second, when a speech rate of fourteen moras per second is set, the length of each phoneme is reduced by half; and when a speech rate of six moras per second is set, the length of each phoneme is multiplied by 7/6. A mora is a unit corresponding to one Kana character that is a phonetic character. One Japanese youon such as “kya” corresponds to one mora. In Japanese, the mora of each character is the same. A youon is, for example, a syllable in which a consonant with a semivowel [j] is prefixed to each of Japanese vowels [a], [u], and [o], or a syllable in which a sound [w] is inserted between the consonant and vowel of each of “ka”, “ga”, “ke”, and “ge”.

The pitch pattern generating unit 20 is pattern generating means for setting a pitch period in each phoneme in consideration of, for example, information on accents in a string of phonetic characters.

The pitch extracting/overlapping unit 10 is pitch extracting and overlapping means in which the Pitch-Synchronous Overlap-add (PSOLA) method (a pitch conversion method by additive superimposition of waveforms) is used. Speech waveforms, phoneme labels that indicate which part corresponds to which phoneme, and pitch marks that indicate pitch periods regarding voice are stored in the waveform dictionary 12. The pitch extracting/overlapping unit 10 extracts speech waveforms for two periods from the waveform dictionary 12 on the basis of the parameters generated in the parameter generating unit 8, multiplies the speech waveforms by a window function (for example, the Hanning window), multiplies the products by a gain for adjusting the amplitude, as necessary, performs pitch conversion when the pitch frequency in the waveform dictionary 12 is different from a desired pitch frequency, and then adds the extracted waveforms in a state in which the waveforms overlap one another to output a synthesized speech signal.

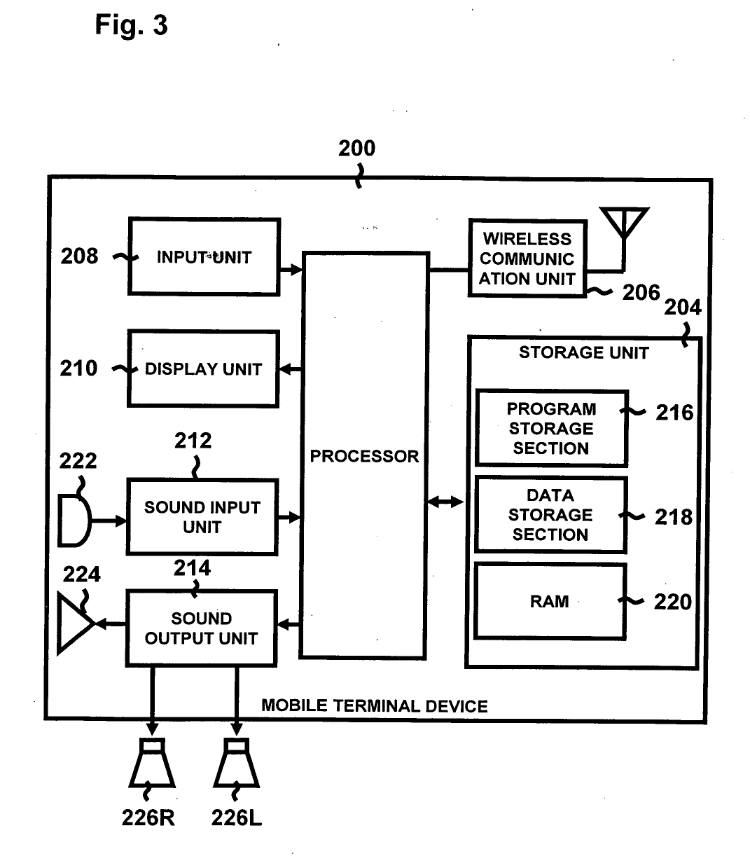

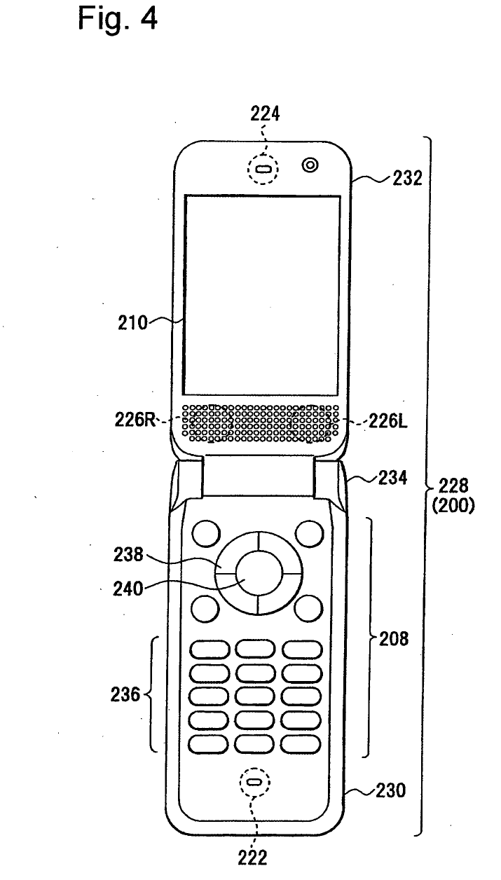

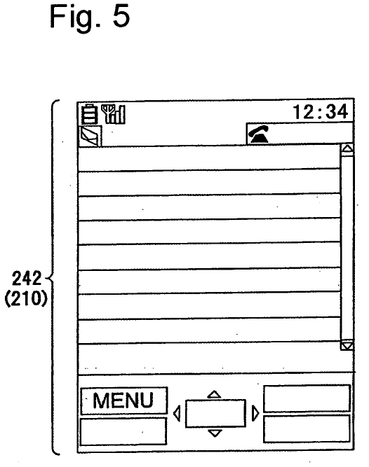

Regarding the hardware of the speech reading apparatus 2, FIGS. 3, 4, and 5 are referred to. FIG. 3 is a block diagram showing an exemplary portable terminal 200 in which the speech reading apparatus 2 is incorporated. FIG. 4 shows an exemplary configuration of the portable terminal 200. FIG. 5 shows an exemplary screen display.

The portable terminal (mobile terminal device, portable terminal device) 200 is just an example to which the aforementioned speech reading apparatus 2 is applied, and the apparatus, the method, and the program according to the present invention for speech reading are not limited to such a configuration. The portable terminal 200 includes, for example, a communication function and a function of converting character data including fricatives and pauses, for example, a text (in the case of Japanese, a text including a mixture of Chinese characters and Japanese kana characters) such as a mail text, to speech and outputting the speech. The portable terminal 200 includes a processor 202, a storage unit 204, a radio unit (wireless communication unit, wireless unit) 206, an input unit 208, a display unit 210, and a speech input unit (sound input unit, voice input unit) 212, and a speech output unit (sound output unit, voice output unit) 214, as shown in FIG. 3.

The processor 202 is control means for controlling telephone communication, speech reading such as speech synthesis, and other processes. The processor 202 includes a central processing unit (CPU) or a microprocessor unit (MPU) and executes an operating system (OS) and application programs in the storage unit 204. These application programs include, for example, a program for performing the procedure for speech reading.

The storage unit 204 is a recording medium in which the programs executed in the processor 202 and various types of data used in the execution of the programs are stored, and a processing area is formed. The storage unit 204 includes a program storage unit 216, a data storage unit 218, and a random access memory (RAM) 220. The program storage unit 216 stores the OS and the application programs. The data storage unit 218 stores the word dictionary 6, the waveform dictionary 12, and the phoneme length table 16 (FIG. 1), in which the aforementioned pieces of data are stored. The RAM 220 constitutes a work area.

The radio unit 206 is radio communication means for sending and receiving, for example, speech signal waves and packet signal waves to and from a base station by air. The radio unit 206 is controlled by the processor 202.

The input unit 208 is means for inputting, by the user's operation, for example, control data and responses in dialogs that appear on the display unit 210. The input unit 208 includes, for example, a keyboard and a touch panel.

The display unit 210 is controlled by the processor 202. The display unit 210 is display means for displaying, for example, characters and figures and includes, for example, liquid crystal display (LCD) elements. For example, a text to be read appears on the display unit 210.

The speech input unit 212 is speech input means controlled by the processor 202 and includes a microphone 222. Input speech is converted to speech signals in the microphone 222, the speech signals are converted to digital signals, and then the digital signals are input to the processor 202.

The speech output unit 214 is speech output means controlled by the processor 202 and includes a receiver 224 and speakers 226R and 226L as speech conversion means. Synthesized speech in speech reading is reproduced from the receiver 224 and the speakers 226R and 226L.

In the portable terminal 200, the speech reading apparatus 2 includes, for example, the processor 202, the storage unit 204, the display unit 210, and the speech output unit 214.

In the portable terminal 200, for example, a housing 228 includes a first housing unit 230 and a second housing unit 232, as shown in FIG. 4. The first housing unit 230 and the second housing unit 232 are joined together with a hinge unit 234 so that the housing 228 can be folded. The first housing unit 230 includes the input unit 208 and the microphone 222. The second housing unit 232 includes the display unit 210, the receiver 224, and the speakers 226R and 226L. The input unit 208 includes keys 236 used to input, for example, characters, a cursor key 238, a conformation key 240, and the like.

Various types of text such as a mail text and a novel text are subjected to speech reading by the portable terminal 200, and, for example, a text that appears on a screen of the display unit 210 is subjected to speech synthesis to be reproduced from the receiver 224 and the speakers 226R and 226L. In this case, a mail text appears on a mail text display screen 242 of the display unit 210, and the mail text is output as speech, as shown in FIG. 5. In this example, a Japanese text “yamanashi ken no koukou wo so tsugyoushi te, shinyou kin koni haitte 4nenme desu.” appears on the mail text display screen 242 and is reproduced as speech. “yamanashi ken no koukou wo so tsugyoshi te shinyou kin koni haitte 4nenme desu” represents Japanese pronunciation. A Japanese sentence “yamanashiken no koukou wo so tsugyoshi te shinyou kin koni haitte 4nenme desu” also means “after he graduated from high school, he has worked at a bank for 4 years” in English.

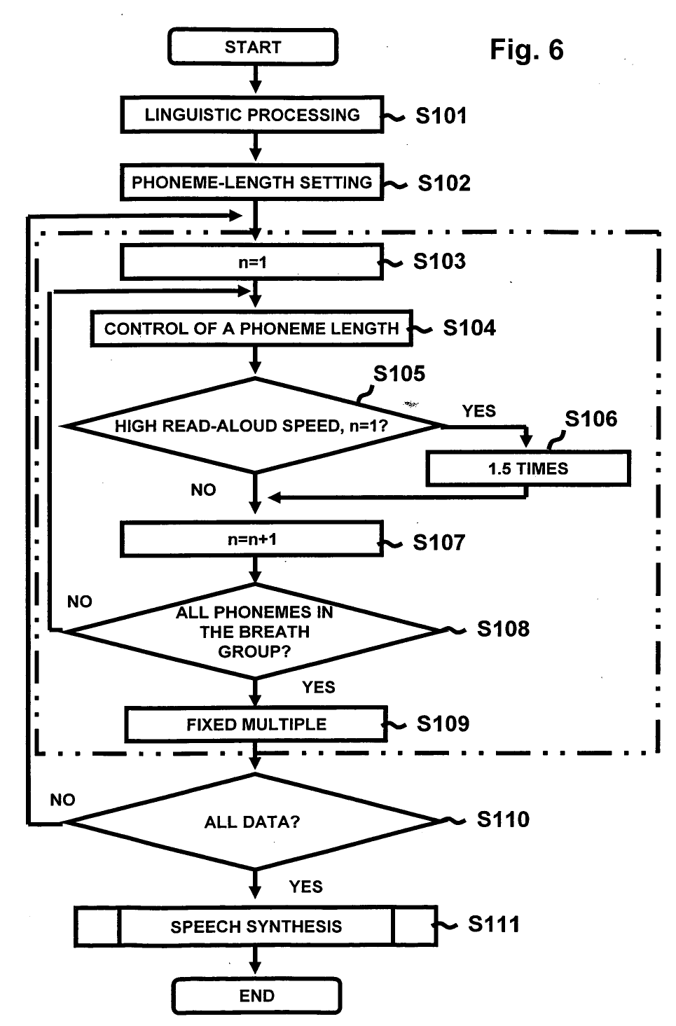

Regarding the control of the phoneme length, FIG. 6 is referred to. FIG. 6 is a flowchart showing exemplary procedure for controlling the phoneme length according to the first embodiment.

The procedure is an exemplary program or an exemplary method for speech reading and includes steps of extending, in speech reading at a high rate, a phoneme when the phoneme is a fricative. The procedure is performed in the phoneme length control unit 18 (FIG. 2) in the speech reading apparatus 2 (FIG. 1). In this embodiment, in order to improve the listenability, the phoneme length of a fricative is corrected in response to the speech rate so as to be, for example, three seconds of the length of other phonemes.

In the procedure, language processing and phoneme length setting are performed in step S101 and step S102, respectively, as shown in FIG. 6. The language processing is performed in the language processing unit 4. In the language processing, a string of phonetic characters is generated from input data. In this stage, it is determined which phonemes are subjected to speech synthesis. Then, the phoneme length setting is performed in the phoneme length setting unit 14. In the phoneme length setting, a phoneme length at the normal speech rate is set for each phoneme. In this case, a phoneme length at the normal speech rate in response to a corresponding phoneme and preceding and following phonemes is set with reference to the phoneme length table 16.

After such phoneme length setting, steps S103 to S110 are performed as processing of phonemes in a breath group. In step S103, a phoneme number n is initialized (n=1). Then, in steps S104 to S110, the phoneme length is controlled in response to the speech rate. The control of the phoneme length is performed for each breath group, and steps S105 to S109 form a loop for processing of phonemes in each breath group. The control of the phoneme length includes determination on phonemes subjected to the control and adjustment of the phoneme length in response to the result of the determination.

In the phoneme length control unit 18, in step S104, input speech rate information is recognized, and the length of a corresponding phoneme is multiplied by a constant factor in response to the speech rate, and then in step S105, it is determined whether the speech rate is a high rate and the corresponding phoneme is a fricative. That is to say, in this determination, the phoneme length of a fricative as an object to be adjusted is determined.

When the speech rate is a high rate and the corresponding phoneme is a fricative, in step S106, the length of the phoneme is further multiplied by a predetermined factor, for example, 3/2. Otherwise, the length of the phoneme is not adjusted. Then, in step S107, the phoneme number n is updated (n=n+1), and in step S108, it is determined whether all the phonemes in the breath group have been processed, i.e., whether the phoneme number n has reached the number of the phonemes in the breath group. In this way, all the phonemes in the breath group are processed.

When all the phonemes in the breath group have been processed and when a pause at the end of the breath group is reached, in step S109, the length of the pause is multiplied by a constant factor in response to the speech rate, and then in step S110, termination determination is performed. In this termination determination, it is determined whether all pieces of the input data have been processed. Until all the pieces of the input data have been processed, steps S103 to S110 are repeated. When it is determined that all the pieces of the input data have been processed, in step S111, speech synthesis is performed to output speech.

In this way, fricatives are corrected for each breath group in response to the speech rate, and in speech reading at a high rate, the phoneme length of each of the fricatives is multiplied by, for example, 3/2, as described above. Thus, indistinctness due to speech reading at a high rate is eliminated, and listenability can be achieved, so that the recognizability of a text converted to speech can be improved.

### Second Embodiment

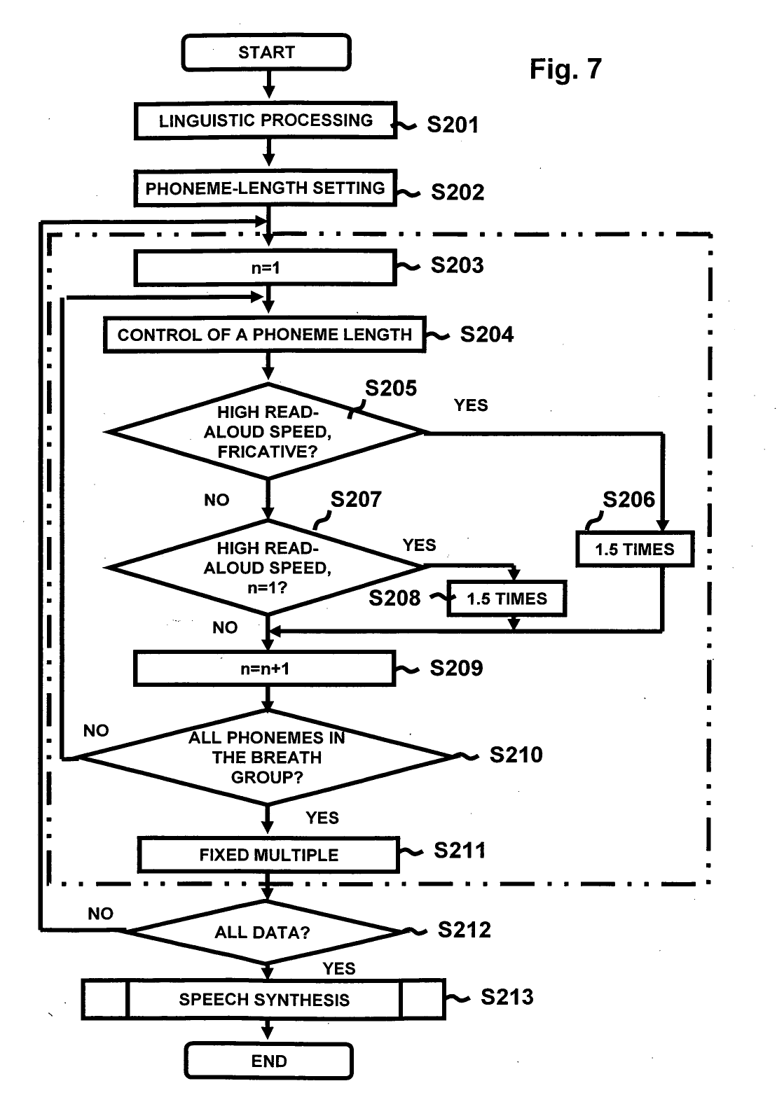

Regarding a second embodiment, FIG. 7 is referred to. FIG. 7 is a flowchart showing exemplary procedure for controlling the phoneme length according to the second embodiment.

The procedure is an exemplary program or an exemplary method for speech reading and includes steps of extending, in speech reading at a high rate, a phoneme when the phoneme is a fricative or a leading phoneme. The procedure is performed using the speech reading apparatus 2 (FIG. 1) and the phoneme length control unit 18 (FIG. 2). In the second embodiment, in speech reading at a high rate, in addition to the adjustment of the phoneme length in the first embodiment, it is determined whether a corresponding phoneme is a leading phoneme, i.e., whether the corresponding phoneme follows a pause, so as to extend the phoneme length of a fricative and the length of a phoneme that follows a pause. Thus, the listenability is improved without the total playback time of speech reading being extended significantly.

In the second embodiment, in order to determine phonemes the length of which needs to be extended, in the phoneme determining unit 28 (FIG. 2), it is determined whether a corresponding phoneme is a fricative, and the phoneme length of a fricative is extended on the basis of the result of the determination.

In the procedure, language processing and phoneme length setting are performed in step S201 and step S202, respectively, as shown in FIG. 7. After the language processing and the phoneme length setting, steps S203 to S211 are performed as processing of phonemes in a breath group. In step S203, the phoneme number n is initialized (n=1). Then, in steps S204 to S211, the phoneme length is controlled in response to the speech rate. The control of the phoneme length is performed for each breath group, as in the first embodiment.

In the phoneme length control unit 18, in step S204, the length of a corresponding phoneme is multiplied by a constant factor in response to input information on the speech rate, and then in step S205, it is determined whether the speech rate is a high rate and the corresponding phoneme is a fricative. That is to say, in this determination, the phoneme length of a fricative as an object to be adjusted is determined.

When the speech rate is a high rate and the corresponding phoneme is a fricative, in step S206, the length of the phoneme is further multiplied by a predetermined factor, for example, 3/2. Otherwise, the length of the phoneme is not adjusted.

Then, in step S207, it is determined whether the speech rate is a high rate and the corresponding phoneme is a leading phoneme (n=1). When the speech rate is a high rate and the corresponding phoneme is a leading phoneme (n=1), in step S208, the length of the phoneme is further multiplied by a predetermined factor, for example, 3/2. Otherwise, the length of the phoneme is not adjusted.

Then, in step S209, the phoneme number n is updated (n=n+1), and in step S210, it is determined whether all the phonemes in the breath group have been processed. In this way, all the phonemes in the breath group are processed.

When all the phonemes in the breath group have been processed and when a pause at the end of the breath group is reached, in step S211, the length of the pause is multiplied by a constant factor in response to the speech rate, and then in step S212, termination determination is performed. Until all the data has been processed, steps S203 to S212 are repeated. When it is determined that all the data has been processed, in step S213, speech synthesis is performed to output speech.

In this way, a leading phoneme and fricatives are corrected for each breath group in response to the speech rate, and the phoneme length of the fricatives and the phoneme following a pause is multiplied by, for example, 3/2, as described above. Thus, the listenability of synthesized speech is improved, so that the recognizability of a text converted to speech is improved.

### Third Embodiment

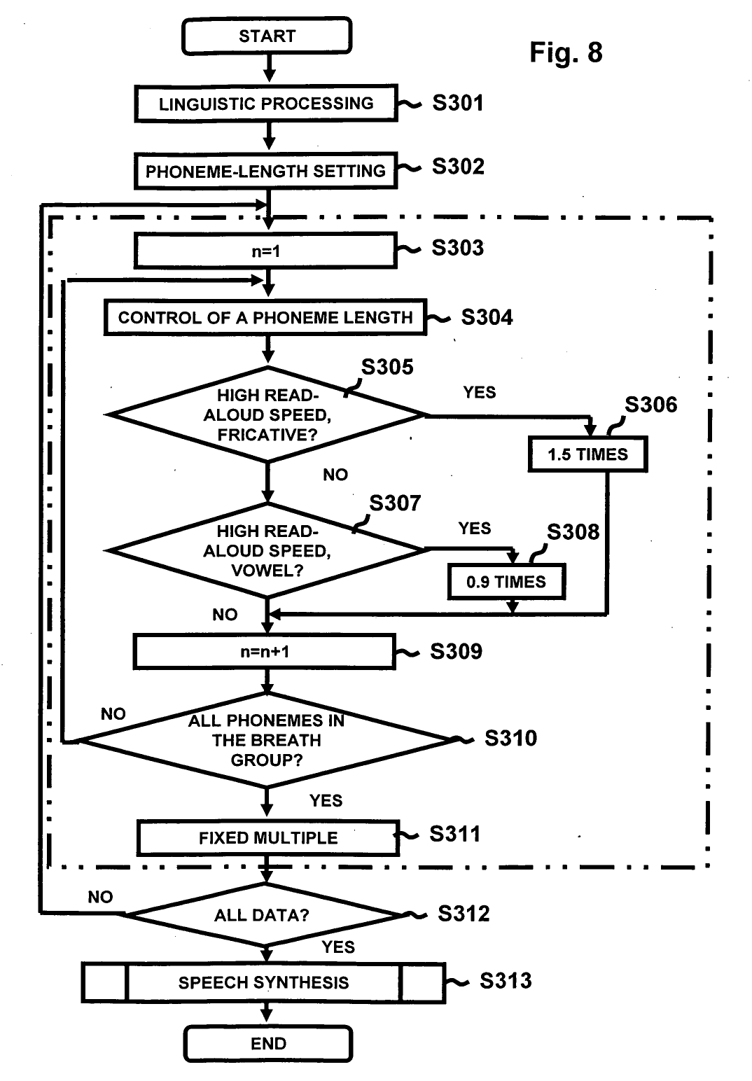

Regarding a third embodiment, FIG. 8 is referred to. FIG. 8 is a flowchart showing exemplary procedure for controlling the phoneme length according to the third embodiment.

The procedure is an exemplary program or an exemplary method for speech reading and includes steps of, in speech reading at a high rate, extending the length of fricatives and shortening the length of other phonemes. The procedure is performed using the speech reading apparatus 2 (FIG. 1) and the phoneme length control unit 18 (FIG. 2). In the third embodiment, in addition to the adjustment of the phoneme length in the first embodiment, the length of other phonemes is shortened. In this embodiment, while the phoneme length of fricatives is extended, the length of other phonemes is shortened. Thus, the listenability is improved without extending the time necessary to convert a text to speech. In this embodiment, the phoneme length of vowels as other phonemes is shortened.

In the third embodiment, in order to determine phonemes the length of which needs to be adjusted, in the phoneme determining unit 28 (FIG. 2), it is determined whether a corresponding phoneme is a vowel, and the phoneme length of a vowel is shortened on the basis of the result of the determination.

In the procedure, language processing and phoneme length setting are performed in step S301 and step S302, respectively, as shown in FIG. 8. Then, steps S303 to S311 are performed as processing of phonemes in a breath group. In step S303, the phoneme number n is initialized (n=1). Then, in steps S304 to S311, the phoneme length is controlled in response to the speech rate. The control of the phoneme length is performed for each breath group, as in the first embodiment.

In the phoneme length control unit 18, in step S304, the length of a corresponding phoneme is multiplied by a constant factor in response to input information on the speech rate, and then in step S305, it is determined whether the speech rate is a high rate and the corresponding phoneme is a fricative. That is to say, in this determination, the phoneme length of a fricative as an object to be adjusted is determined.

When the speech rate is a high rate and the corresponding phoneme is a fricative, in step S306, the length of the phoneme is further multiplied by a predetermined factor, for example, 3/2. Otherwise, the length of the phoneme is not adjusted.

Then, in step S307, it is determined whether the speech rate is a high rate and the corresponding phoneme is a vowel. When the speech rate is a high rate and the corresponding phoneme is a vowel, in step S308, the length of the phoneme is further multiplied by a predetermined factor, for example, 9/10. Otherwise, the length of the phoneme is not adjusted.

Then, in step S309, the phoneme number n is updated (n=n+1), and in step S310, it is determined whether all the phonemes in the breath group have been processed. After all the phonemes in the breath group are processed, when a pause at the end of the breath group is reached, in step S311, the length of the pause is multiplied by a constant factor in response to the speech rate, and then in step S312, termination determination is performed. Until all the data has been processed, steps S303 to S312 are repeated. When it is determined that all the data has been processed, in step S313, speech synthesis is performed to output speech.

In this way, the phoneme length of fricatives and vowels are corrected for each breath group in response to the speech rate. While the phoneme length of the fricatives is multiplied by, for example, 3/2, the phoneme length of the vowels is multiplied by, for example, 9/10, as described above. The shortening of the phoneme length of the vowels compensates for the extension of the phoneme length of the fricatives. Thus, while the total playback time of output speech is not extended and is kept substantially constant, the listenability of synthesized speech is improved, so that the recognizability of a text converted to speech is improved.

### Fourth Embodiment

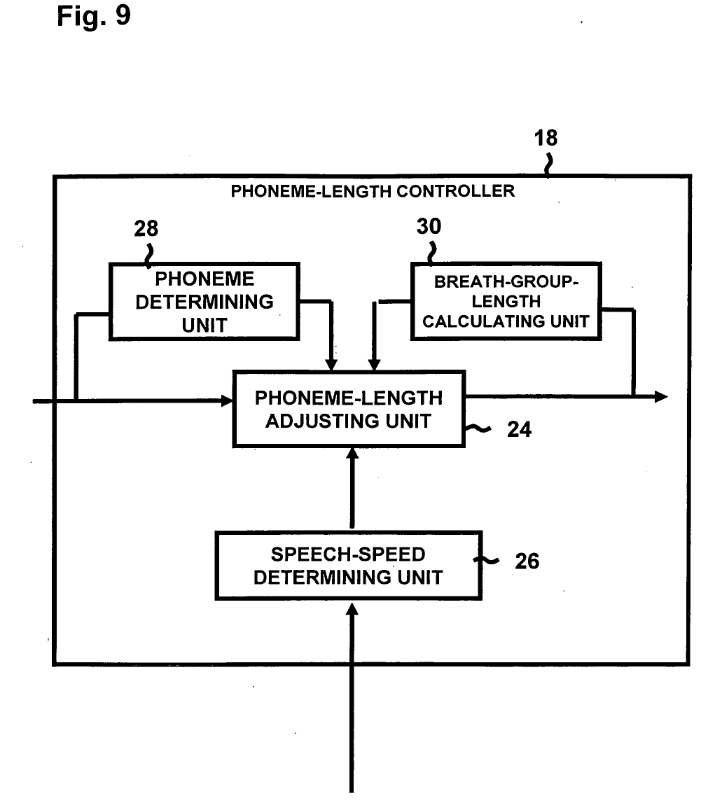

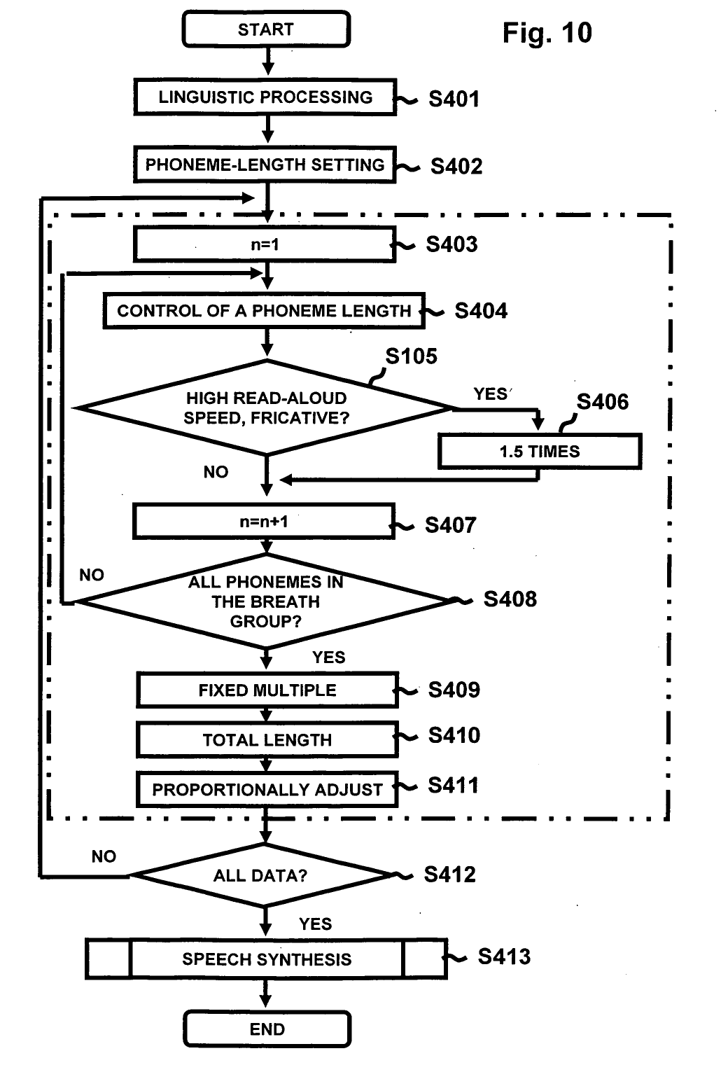

Regarding a fourth embodiment, FIGS. 9 and 10 are referred to. FIG. 9 is a block diagram showing the phoneme length control unit 18 according to the fourth embodiment. FIG. 10 is a flowchart showing exemplary procedure for controlling the phoneme length according to the fourth embodiment. In FIG. 9, the same reference numerals as in FIG. 2 are assigned to corresponding components.

The procedure is an exemplary program or an exemplary method for speech reading and is performed using the speech reading apparatus 2 (FIG. 1) and the phoneme length control unit 18 (FIG. 2). In the fourth embodiment, in addition to the adjustment of the phoneme length in the first embodiment, i.e., the extension of the phoneme length of fricatives, the extension of the phoneme length of the fricatives is cut by allocating the extension proportionally to phonemes in a breath group. Thus, while the length of a breath group is kept, i.e., the time necessary to convert a text to speech is not extended, the listenability is improved.

In the fourth embodiment, the phoneme length control unit 18 (FIG. 2) in the speech reading apparatus 2 (FIG. 1) further includes a breath group length calculating unit (phrase length calculating unit) 30, as shown in FIG. 9. The breath group length calculating unit 30 calculates the total length of a breath group from the output from the phoneme length adjusting unit 24. The result of the calculation is supplied to the phoneme length adjusting unit 24 as control information. The phoneme length adjusting unit 24 includes a function of reducing the length of all phonemes by allocating extension of the length of specific phonemes (in this case, fricatives) proportionally to all the phonemes in a breath group so that the length of time necessary to read the breath group is equal to a predetermined length.

In the procedure, language processing and phoneme length setting are performed in step S401 and step S402, respectively, as shown in FIG. 10. Then, steps S403 to S412 are performed as processing of phonemes in a breath group. In step S403, the phoneme number n is initialized (n=1). Then, in steps S404 to S412, the phoneme length is controlled in response to the speech rate. The control of the phoneme length is performed for each breath group, as in the first embodiment.

In the phoneme length control unit 18, in step S404, the length of a corresponding phoneme is multiplied by a constant factor in response to input information on the speech rate, and then in step S405, it is determined whether the speech rate is a high rate and the corresponding phoneme is a fricative. That is to say, in this determination, the phoneme length of a fricative as an object to be adjusted is determined.

When the speech rate is a high rate and the corresponding phoneme is a fricative, in step S406, the length of the phoneme is further multiplied by a predetermined factor, for example, 3/2. Otherwise, the length of the phoneme is not adjusted.

Then, in step S407, the phoneme number n is updated (n=n+1), and in step S408, it is determined whether all the phonemes in the breath group have been processed. After all the phonemes in the breath group are processed, when a pause at the end of the breath group is reached, in step S409, the length of the pause is multiplied by a constant factor in response to the speech rate.

Then, in step S410, the total length of the breath group is calculated, and in step S411, the total of the lengths of all the phonemes is allocated proportionally to the phonemes so that the length of the breath group is equal to a predetermined length, for example, a length equal to or substantially equal to the length of the breath group in a case where the phoneme length of fricatives is not extended. Then, in step S412, termination determination is performed. Until all the data has been processed, steps S403 to S412 are repeated. When it is determined that all the data has been processed, in step S413, speech synthesis is performed to output speech.

In this way, the phoneme length of fricatives is corrected for each breath group in response to the speech rate. While the phoneme length of the fricatives is multiplied by, for example, 3/2, the extension of the phoneme length of the fricatives is cut by allocating the extension proportionally to phonemes in the breath group, as described above. Thus, while the length of the breath group is kept, the listenability of synthesized speech is improved, so that the recognizability of a text converted to speech is improved.

### Fifth Embodiment

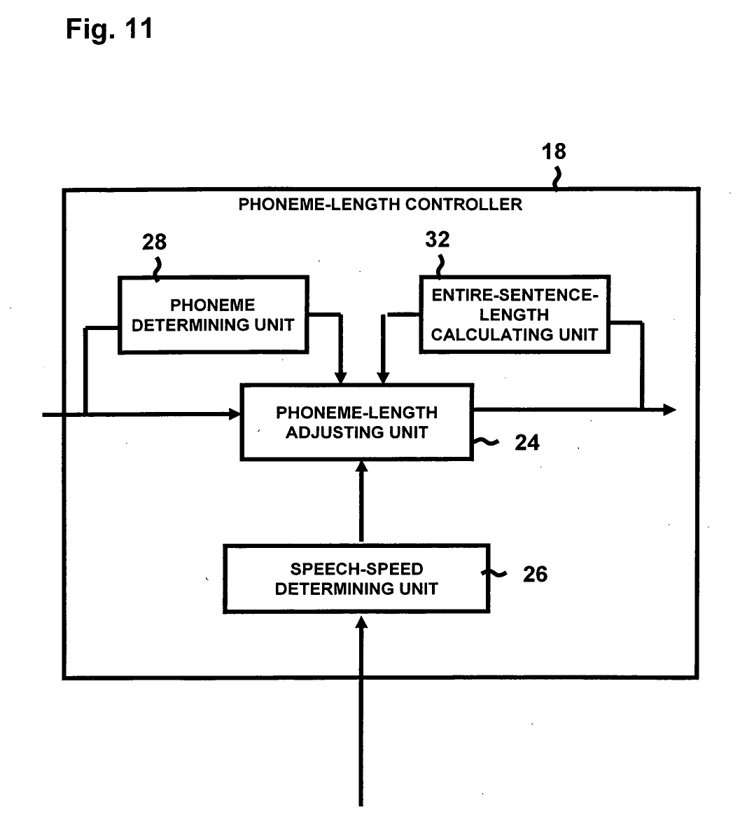

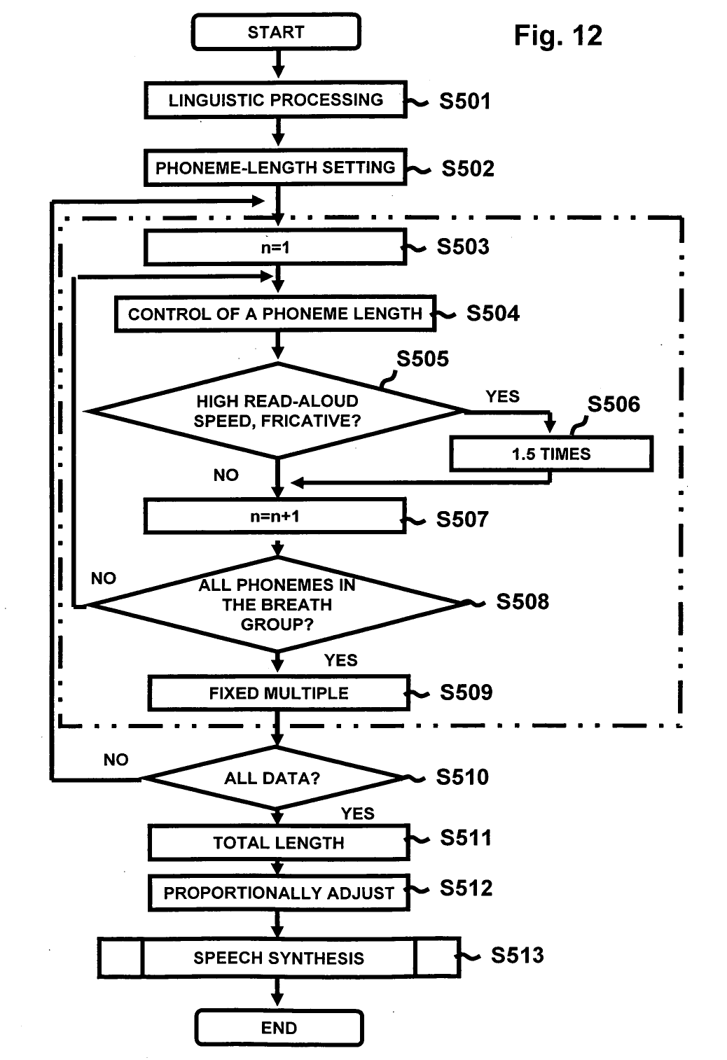

Regarding a fifth embodiment, FIGS. 11 and 12 are referred to. FIG. 11 is a block diagram showing the phoneme length control unit 18 according to the fifth embodiment. FIG. 12 is a flowchart showing exemplary procedure for controlling the phoneme length according to the fifth embodiment. In FIG. 11, the same reference numerals as in FIG. 2 are assigned to corresponding components.

The procedure is an exemplary program or an exemplary method for speech reading and is performed using the speech reading apparatus 2 (FIG. 1) and the phoneme length control unit 18 (FIG. 2). In the fifth embodiment, in addition to the adjustment of the phoneme length in the first embodiment, the length of other phonemes is shortened. In this embodiment, while the phoneme length of fricatives is extended, the extension of the phoneme length of the fricatives is cut by allocating the extension proportionally to phonemes in a whole text. Thus, while the length of the whole text is kept, i.e., the time necessary to convert the text to speech is not extended, the listenability is improved.

In the fifth embodiment, the phoneme length control unit 18 (FIG. 2) in the speech reading apparatus 2 (FIG. 1) further includes a total text length calculating unit (entire-sentence-length calculating unit) 32, as shown in FIG. 11. The total text length calculating unit 32 calculates the length of a whole text from the output from the phoneme length adjusting unit 24. The result of the calculation is supplied to the phoneme length adjusting unit 24 as control information. The phoneme length adjusting unit 24 includes a function of reducing the length of all phonemes by allocating extension of the length of specific phonemes (in this case, fricatives) proportionally to all the phonemes in a whole text so that the length of time necessary to read the text is equal to a predetermined length.

In the procedure, language processing and phoneme length setting are performed in step S501 and step S502, respectively, as shown in FIG. 12. Then, steps S503 to S512 are performed as processing of phonemes in a breath group. In step S503, the phoneme number n is initialized (n=1). Then, in steps S504 to S512, the phoneme length is controlled in response to the speech rate. The control of the phoneme length is performed for each breath group, as in the first embodiment.

In the phoneme length control unit 18, in step S504, the length of a corresponding phoneme is multiplied by a constant factor in response to input information on the speech rate, and then in step S505, it is determined whether the speech rate is a high rate and the corresponding phoneme is a fricative. That is to say, in this determination, the phoneme length of a fricative as an object to be adjusted is determined.

When the speech rate is a high rate and the corresponding phoneme is a fricative, in step S506, the length of the phoneme is further multiplied by a predetermined factor, for example, 3/2. Otherwise, the length of the phoneme is not adjusted.

Then, in step S507, the phoneme number n is updated (n=n+1), and in step S508, it is determined whether all the phonemes in the breath group have been processed. After all the phonemes in the breath group are processed, when a pause at the end of the breath group is reached, in step S509, the length of the pause is multiplied by a constant factor in response to the speech rate, and then in step S510, termination determination is performed. Until all the data has been processed, steps S503 to S510 are repeated.

After all the data is processed, in step S511, the length of a whole text is calculated, and in step S512, the total of the lengths of all phonemes in the whole text is allocated proportionally to the phonemes so that the length of the whole text, i.e., the time necessary to reading the text, is a predetermined length, for example, a length equal to or substantially equal to the length of the whole text in a case where the phoneme length of fricatives is not extended. Then, in step S513, speech synthesis is performed to output speech.

In this way, the phoneme length of fricatives is corrected for each breath group in response to the speech rate. While the phoneme length of the fricatives is multiplied by, for example, 3/2, the extension of the phoneme length of the fricatives is cut by allocating the extension proportionally to all phonemes in a whole text, as described above. Thus, while the length of time necessary to read the whole text is kept, the listenability of synthesized speech is improved, so that the recognizability of a text converted to speech is improved.

### Sixth Embodiment

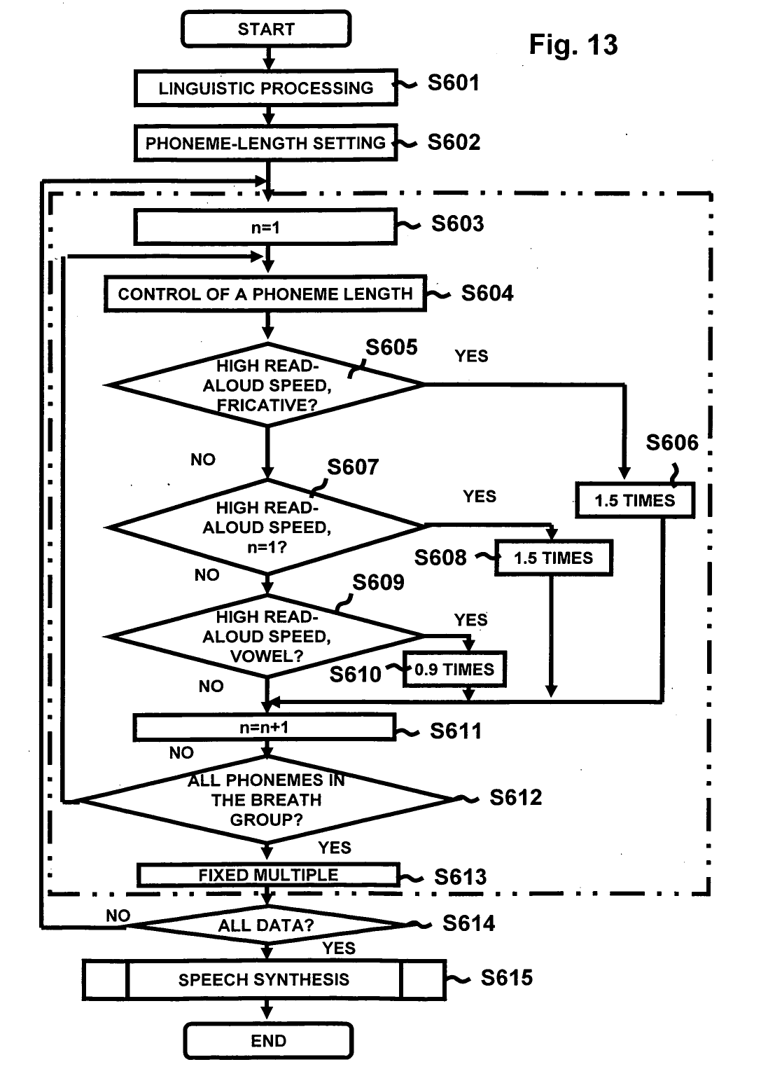

Regarding a sixth embodiment, FIG. 13 is referred to. FIG. 13 is a flowchart showing exemplary procedure for controlling the phoneme length according to the sixth embodiment.

The procedure is an exemplary program or an exemplary method for speech reading and is performed using the speech reading apparatus 2 (FIG. 1) and the phoneme length control unit 18 (FIG. 2). In the sixth embodiment, the adjustment of the phoneme length in the second embodiment (FIG. 7) and the adjustment of the phoneme length in the third embodiment (FIG. 8) are used in combination. While the phoneme length of a leading phoneme and fricatives is extended, the length of other phonemes, for example, vowels, is shortened. Thus, the listenability is improved without extending the time necessary to convert a text to speech.

In the procedure, language processing and phoneme length setting are performed in step S601 and step S602, respectively, as shown in FIG. 13. Then, steps S603 to S613 are performed as processing of phonemes in a breath group. In step S603, the phoneme number n is initialized (n=1). Then, in steps S604 to, S613, the phoneme length is controlled in response to the speech rate. The control of the phoneme length is performed for each breath group, as in the second embodiment (FIG. 7).

In step S604, the length of a corresponding phoneme is multiplied by a constant factor in response to the speech rate, and then in step S605, it is determined whether the speech rate is a high rate and the corresponding phoneme is a fricative. When the speech rate is a high rate and the corresponding phoneme is a fricative, in step S606, the length of the phoneme is further multiplied by a predetermined factor, for example, 3/2. In step S607, it is determined whether the speech rate is a high rate and the corresponding phoneme is a leading phoneme (n=1). When the speech rate is a high rate and the corresponding phoneme is a leading phoneme (n=1), in step S608, the length of the phoneme is further multiplied by a predetermined factor, for example, 3/2.

Then, in step S609, it is determined whether the speech rate is a high rate and the corresponding phoneme is a vowel. When the speech rate is a high rate and the corresponding phoneme is a vowel, in step S610, the length of the phoneme is further multiplied by a predetermined factor, for example, 9/10. Otherwise, the length of the phoneme is not adjusted.

Then, in step S611, the phoneme number n is updated (n=n+1). In step S612, it is determined whether all the phonemes in the breath group have been processed. When a pause at the end of the breath group is reached, in step S613, the length of the pause is multiplied by a constant factor in response to the speech rate. In step S614, termination determination is performed. Then, in step S615, speech synthesis is performed.

In this way, the phoneme length of a leading phoneme and fricatives is corrected for each breath group in response to the speech rate. While the phoneme length of the fricatives and the phoneme following a pause is multiplied by, for example, 3/2, the phoneme length of vowels is multiplied by, for example, 9/10 to be shortened, as described above. The extension of the playback time due to the extension of the phoneme length of the phoneme following a pause and the fricatives is reduced as much as the shortening of the phoneme length of the vowels. Thus, while the total playback time of output speech is not extended (in some cases, the total playback time is shortened) and is kept substantially constant, the listenability of synthesized speech is improved, so that the recognizability of a text converted to speech is improved.

### Seventh Embodiment

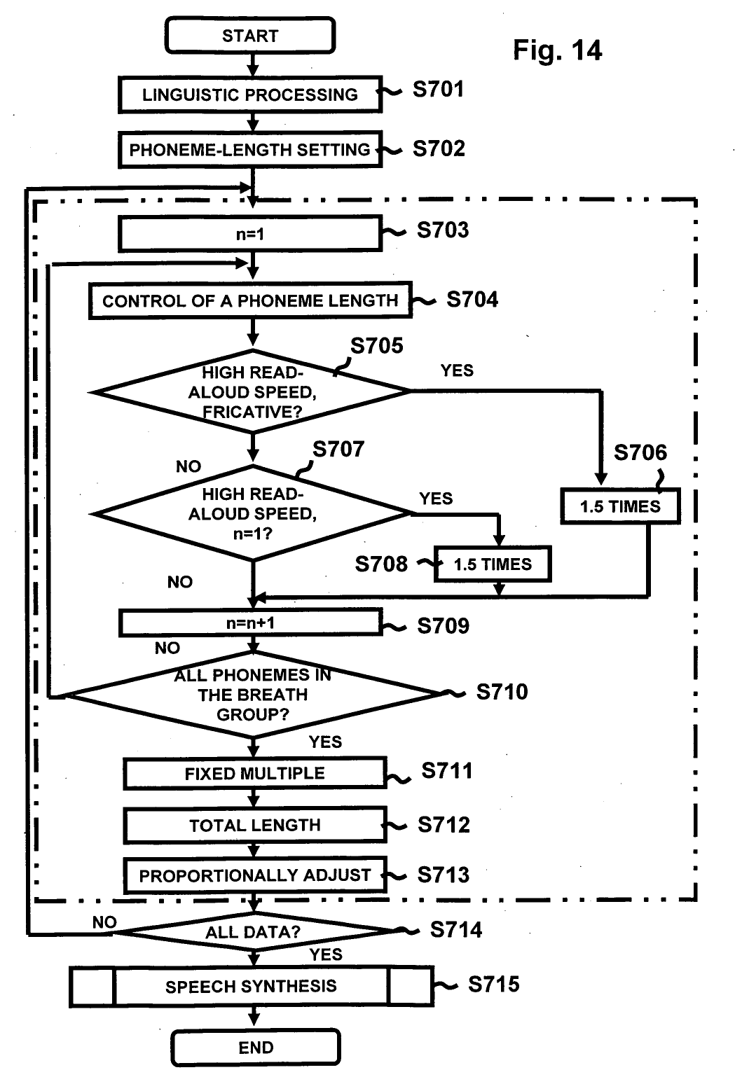

Regarding a seventh embodiment, FIG. 14 is referred to. FIG. 14 is a flowchart showing exemplary procedure for controlling the phoneme length according to the seventh embodiment.

The procedure is an exemplary program or an exemplary method for speech reading and is performed using the speech reading apparatus 2 (FIG. 1) and the phoneme length control unit 18 (FIG. 2). In this embodiment, in addition to the adjustment of the phoneme length in the second embodiment (FIG. 7), i.e., the extension of the phoneme length of a leading phoneme and fricatives, an arrangement is provided, in which the length of other phonemes, for example, a pause, corresponding to the extension of the phoneme length is not reserved or is reduced. In this arrangement, the extension of the phoneme length of the leading phoneme and the fricatives is cut by allocating the extension proportionally to phonemes in a breath group. Thus, while the length of the breath group is kept, i.e., the time necessary to convert a text to speech is not extended, the listenability is improved.

In the seventh embodiment, the breath group length calculating unit 30 is provided for the phoneme length adjusting unit 24 in the phoneme length control unit 18, as in the fourth embodiment (FIG. 9). The breath group length calculating unit 30 calculates the total length of a breath group from the output from the phoneme length adjusting unit 24. The result of the calculation is supplied to the phoneme length adjusting unit 24 as control information. The phoneme length adjusting unit 24 includes a function of reducing the length of all phonemes by allocating extension of the length of specific phonemes (in this case, fricatives and a leading phoneme) proportionally to all the phonemes in a breath group so that the length of time necessary to read the breath group is equal to a predetermined length.

In the procedure, language processing and phoneme length setting are performed in step S701 and step S702, respectively, as shown in FIG. 14. Then, steps S703 to S713 are performed as processing of phonemes in a breath group. In step S703, the phoneme number n is initialized (n=1). Then, in steps S704 to S713, the phoneme length is controlled in response to the speech rate. The control of the phoneme length is performed for each breath group, as in the second embodiment (FIG. 7).

In step S704, the length of a corresponding phoneme is multiplied by a constant factor in response to the speech rate, and then in step S705, it is determined whether the speech rate is a high rate and the corresponding phoneme is a fricative. When the speech rate is a high rate and the corresponding phoneme is a fricative, in step S706, the length of the phoneme is further multiplied by a predetermined factor, for example, 3/2. In step S707, it is determined whether the speech rate is a high rate and the corresponding phoneme is a leading phoneme (n=1). When the speech rate is a high rate and the corresponding phoneme is a leading phoneme (n=1), in step S708, the length of the phoneme is further multiplied by a predetermined factor, for example, 3/2.

Then, in step S709, the phoneme number n is updated (n=n+1), and in step S710, it is determined whether all the phonemes in the breath group have been processed. When a pause at the end of the breath group is reached, in step S711, the length of the pause is multiplied by a constant factor in response to the speech rate. Then, in step S712, the total length of the breath group is calculated, and in step S713, the total of the lengths of all the phonemes is allocated proportionally to the phonemes so that the length of the breath group is equal to a predetermined length, for example, a length equal to or substantially equal to the length of the breath group in a case where the phoneme length is not extended. Then, in step S714, termination determination is performed. Until all the data has been processed, steps S703 to S714 are repeated. When it is determined that all the data has been processed, in step S715, speech synthesis is performed to output speech.

In this way, the phoneme length of a leading phoneme and fricatives is corrected for each breath group in response to the speech rate. While the phoneme length of the fricatives and the phoneme following a pause is multiplied by, for example, 3/2, the extension of the phoneme length of these phonemes is cut by allocating the extension proportionally to phonemes in the breath group. Thus, while the length of the breath group is kept, the listenability of synthesized speech is improved, so that the recognizability of a text converted to speech is improved.

### Eighth Embodiment

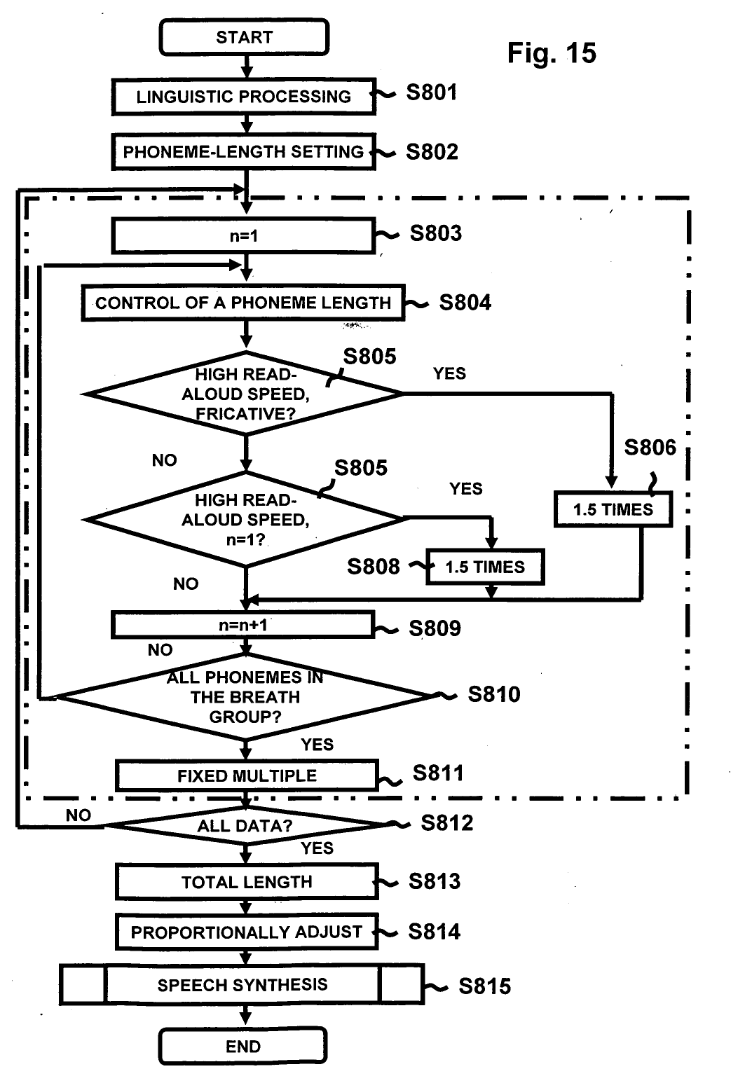

Regarding an eighth embodiment, FIG. 15 is referred to. FIG. 15 is a flowchart showing exemplary procedure for controlling the phoneme length according to the eighth embodiment.

The procedure is an exemplary program or an exemplary method for speech reading and is performed using the speech reading apparatus 2 (FIG. 1) and the phoneme length control unit 18 (FIG. 2). In this embodiment, in addition to the adjustment of the phoneme length in the second embodiment (FIG. 7), the extension of the phoneme length of fricatives and a leading phoneme is cut by allocating the extension proportionally to phonemes in a whole text. Thus, while the length of the whole text is kept, i.e., the time necessary to convert a text to speech is not extended, the listenability is improved.

In the eighth embodiment, the phoneme length control unit 18 in the speech reading apparatus 2 (FIG. 1) includes the total text length calculating unit 32, as in the fifth embodiment (FIG. 11). The total text length calculating unit 32 calculates the length of a whole text from the output from the phoneme length adjusting unit 24. The result of the calculation is supplied to the phoneme length adjusting unit 24 as control information. The phoneme length adjusting unit 24 includes a function of reducing the length of all phonemes by allocating extension of the length of specific phonemes (in this case, a leading phoneme and fricatives) proportionally to all the phonemes in a whole text so that the length of time necessary to read the text is equal to a predetermined length.

In the procedure, language processing and phoneme length setting are performed in step S801 and step S802, respectively, as shown in FIG. 15. Then, steps S803 to S811 are performed as processing of phonemes in a breath group. In step S803, the phoneme number n is initialized (n=1). Then, in steps S804 to S811, the phoneme length is controlled in response to the speech rate. The control of the phoneme length is performed for each breath group, as in the second embodiment (FIG. 7).

In step S804, the length of a corresponding phoneme is multiplied by a constant factor in response to the speech rate, and then in step S805, it is determined whether the speech rate is a high rate and the corresponding phoneme is a fricative. When the speech rate is a high rate and the corresponding phoneme is a fricative, in step S806, the length of the phoneme is further multiplied by a predetermined factor, for example, 3/2. In step S807, it is determined whether the speech rate is a high rate and the corresponding phoneme is a leading phoneme (n=1). When the speech rate is a high rate and the corresponding phoneme is a leading phoneme (n=1), in step S808, the length of the phoneme is further multiplied by a predetermined factor, for example, 3/2.

Then, in step S809, the phoneme number n is updated (n=n+1), and in step S810, it is determined whether all the phonemes in the breath group have been processed. When a pause at the end of the breath group is reached, in step S811, the length of the pause is multiplied by a constant factor in response to the speech rate. Then, in step S812, termination determination is performed.

After all the data is processed, in step S813, the length of a whole text is calculated, and in step S814, the total of the lengths of all phonemes in the whole text is allocated proportionally to the phonemes so that the length of the whole text, i.e., the time necessary to reading the text, is a predetermined length, for example, a length equal to or substantially equal to the length of the whole text in a case where the phoneme length is not extended. Then, in step S815, speech synthesis is performed to output speech.

In this way, the phoneme length of a leading phoneme and fricatives is corrected for each breath group in response to the speech rate. While the phoneme length of the fricatives and the phoneme following a pause is multiplied by, for example, 3/2, the extension of the phoneme length is cut by allocating the extension proportionally to all phonemes in a whole text. Thus, while the length of time necessary to read the whole text is kept, the listenability of synthesized speech is improved, so that the recognizability of a text converted to speech is improved.

### Other Embodiments

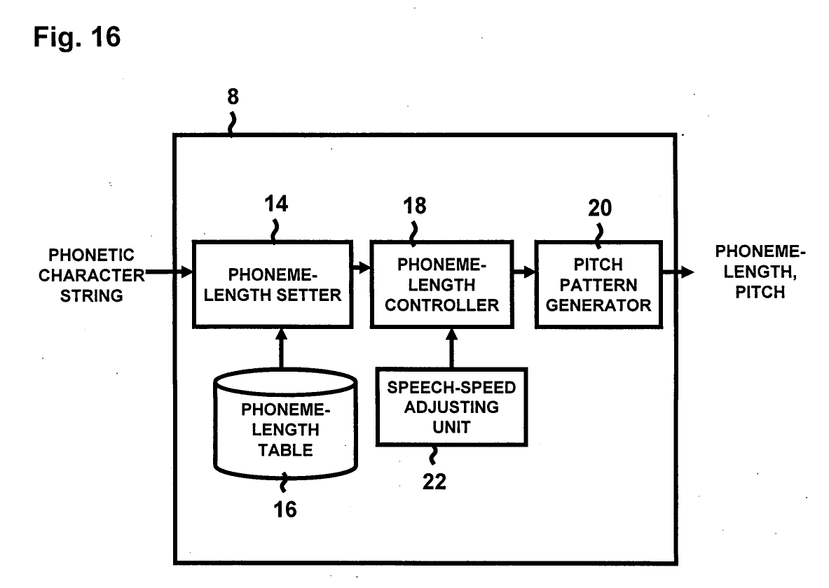

Regarding speech rate information input to the phoneme length control unit 18, FIG. 16 is referred to. FIG. 16 is a block diagram showing the parameter generating unit 8, which includes a speech rate adjusting unit 22. In the aforementioned embodiments, speech rate information is input to the phoneme length control unit 18. The parameter generating unit 8 may include the speech rate adjusting unit 22, which can be externally adjusted, so that a desired speech rate can be externally set.

While the cases where the phoneme length of, for example, fricatives is extended have been described in the aforementioned embodiments, the present invention can be applied to a case where the phoneme length is shortened.

In the first embodiment, the portable terminal 200 (FIGS. 3 and 4) is shown as an example. However, the present invention is not limited to the aforementioned embodiments and can be applied to, for example, a Personal Digital Assistant (PDA), electronic equipment, that includes a computer and outputs speech, such as a personal computer, and various types of equipment in which an electronic equipment unit is incorporated.

While fricatives, vowels, and consonants have been described as examples in the aforementioned embodiments, the present invention can support other phonemes, such as semivowels, youons, and affricates. In this case, a semivowel is similar in the manner of articulation to a vowel. However, a semivowel does not form a syllable alone. Exemplary semivowels include [w] and [j]. An affricate is a sound in which a fricative follows a plosive, and the fricative and the plosive are treated as one sound. Examplery affricates include [ts], [dz], and [t∫].

In the aforementioned embodiments, when the speech rate is high, some or all of pauses in character data may be deleted. The playback time can be reduced without impairing the listenability by deleting pauses.

### EXAMPLES

### First Example

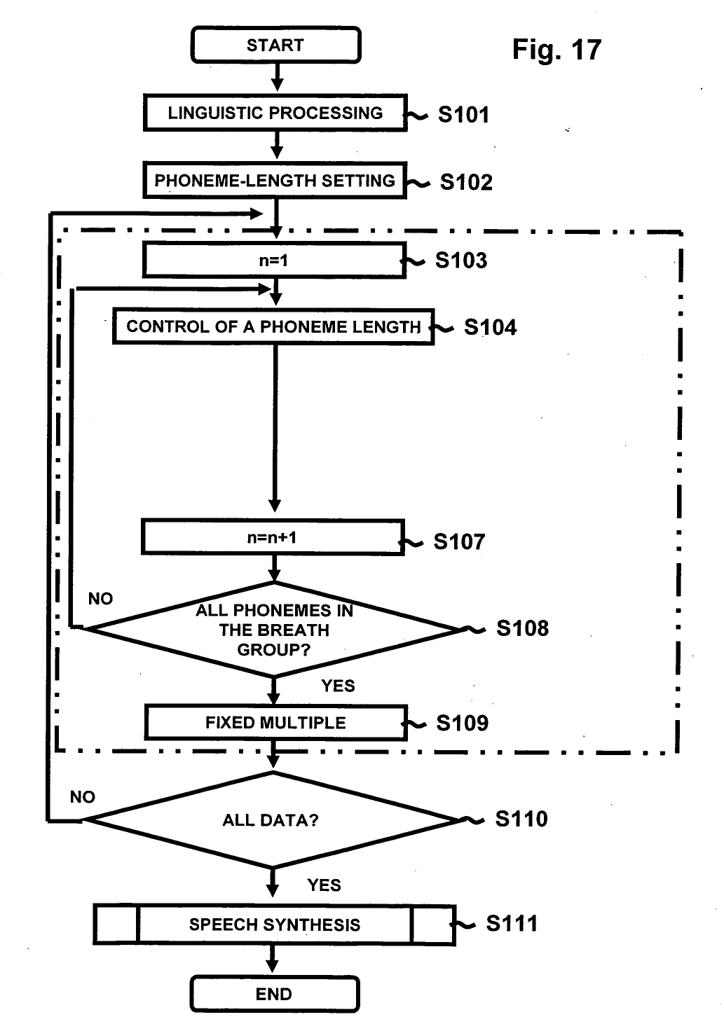

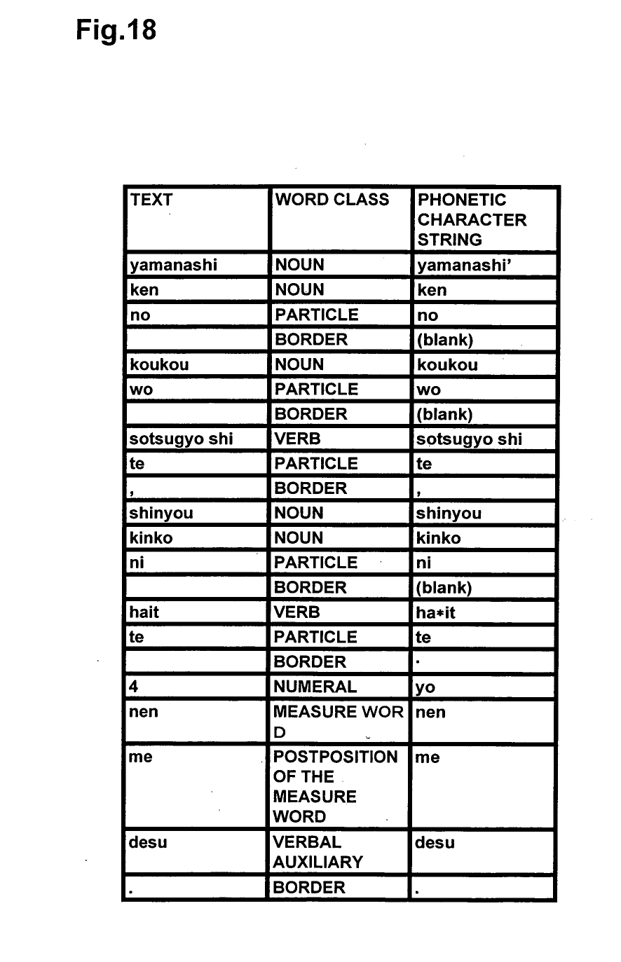

Regarding a first example, FIGS. 17 and 18 are referred to. FIG. 17 is a flowchart showing a comparative example, corresponding to the flowchart in FIG. 6. FIG. 18 shows the result of language processing.

In the speech reading apparatus 2 (FIG. 1), when the lengths of individual phonemes are extended in response to the speech rate in the same manner, processing shown in the flowchart in FIG. 17 is performed. In this case, the same reference numerals as in the flowchart in FIG. 6 are assigned to corresponding steps, and processing in which the phoneme length of fricatives is not adjusted is shown. That is to say, the flowchart in FIG. 17 does not include steps S105 and S106 in the flowchart in FIG. 6. In the processing shown in FIG. 17, the phoneme length of fricatives is not extended in speech reading at a high rate, and the phoneme length is multiplied by a constant factor that varies inversely as the speech rate.

In such processing, when an exemplary input text is a Japanese text “yamanashi ken no koukou o so tsugyoushi te, shinyou kin koni haitte yonenme desu.” (FIG. 5), the result of analysis of words can be shown with input texts, parts of speech, and phonetic characters, as shown in FIG. 18.

In the Japanese text “yamanashi ken no koukou o so tsugyoushi te, shinyou kin koni haitte yonenme desu.”, “yamanashi” is a noun, and a corresponding string of phonetic characters is “yamanashi”; “ken” is a noun, and a corresponding string of phonetic characters is “ken”; “no” is a Japanese particle joshi, and a corresponding string of phonetic characters is “no”; a blank that follows “no” is an accent phrase boundary; “koukou” is a noun, and a corresponding string of phonetic characters is “koukou”; “o” is a Japanese particle joshi, and a corresponding string of phonetic characters is “o”; a blank that follows “o” is an accent phrase boundary; “so tsugyoushi” is a verb (a renyou form (a Japanese conjugation form for verbs and adjectives)), and a corresponding string of phonetic characters is “so tsugyoushi”; “te” is a Japanese particle joshi, and a corresponding string of phonetic characters is “te”; “,” is a breath group boundary (the pause length is medium), and a corresponding string of phonetic characters is “,”; “shinyou” is a noun, and a corresponding string of phonetic characters is “shinyoo”; “kin ko” is a noun, and a corresponding string of phonetic characters is “ki'nko”; “ni” is a Japanese particle joshi, and a corresponding string of phonetic characters is “ni”; a blank that follows “ni” is an accent phrase boundary; “hait” is a verb (a renyou form (a Japanese conjugation form for verbs and adjectives), Japanese sokuon-bin), and a corresponding string of phonetic characters is “ha*it”; “te” is a Japanese particle joshi, and a corresponding string of phonetic characters is “te”; a part that follows “te” is a breath group boundary (the pause length is small), and a corresponding string of phonetic characters is “•”; “yo” is a numeral, and a corresponding string of phonetic characters is “yo”; “nen” is a Japanese josuushi (a counter word, a Japanese part of speech), and a corresponding string of phonetic characters is “nen”; “me” is a postposition of a josuushi, and a corresponding string of phonetic characters is “me′”; “desu” is an auxiliary verb, and a corresponding string of phonetic characters is “desu”; and “.” is a breath group boundary (the pause length is large), and a corresponding string of phonetic characters is “.”. Thus, the string of phonetic characters for the aforementioned exemplary Japanese text is “yamanashi′ ken no koukou o so tsugyoushi te, shinyoo ki'n koni ha*itte•yonenme′ desu.”.

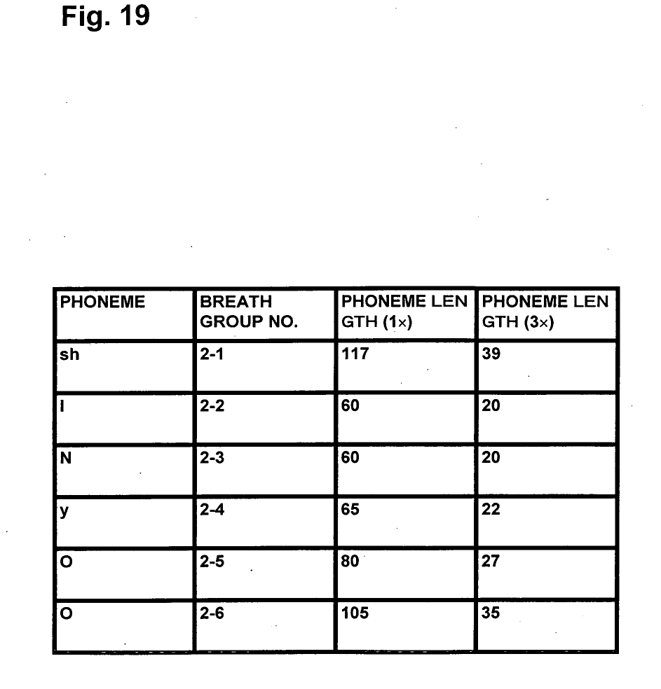

Regarding generation of the phoneme lengths of the part “shinyoo” of this string of phonetic characters and correction of the phoneme lengths in response to the speech rate, FIG. 19 is referred to. FIG. 19 shows examples of generated phoneme lengths in this case. In FIG. 18, the input text and phonetic character strings are written by using Roman characters, but the input text is different from phonetic character strings as data. In other words, the speech reading apparatus 2 transforms the input text into phonetic character strings.

In these examples, assuming that about seven moras per second is 1× speed, when phoneme lengths at 3× speed (about twenty-one moras per second) are generated, phoneme lengths at 1× speed are read from the phoneme length table 16 (FIG. 1), and the phoneme lengths are corrected so as to vary inversely as the speech rate. After the correction of the phoneme lengths, a pitch pattern is generated on the basis of information on, for example, accents, and speech waveforms are synthesized.

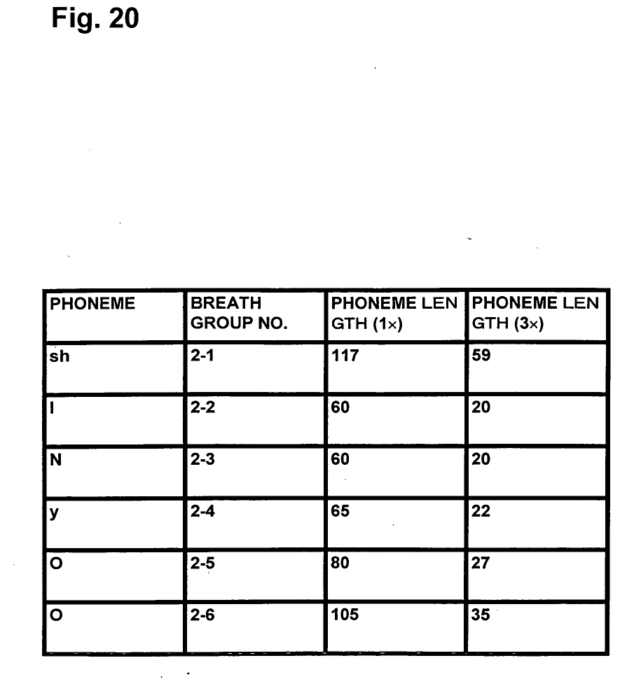

On the other hand, regarding the result of processing in the first embodiment (FIG. 6), FIG. 20 is referred to. FIG. 20 shows examples of generated phoneme lengths in the first embodiment (FIG. 6).

In this case, when phoneme lengths at 3× speed are generated, a phoneme length of “sh” that is a fricative is generated by multiplying a phoneme length of “sh” derived on the basis of a simple inverse relationship by 3/2. As a result, while a phoneme length of “sh” at 1× speed is 117 ms, a phoneme length of “sh” at 3× speed is 59 ms, as shown in FIG. 20. Comparing these phoneme lengths with lengths of other phonemes “i”, “n”, “y”, “o”, and “o” shows that, at 1× speed, since the phoneme length of the phoneme “sh” is 117 ms while the phoneme lengths of the other phonemes “i”, “n”, “y”, “o”, and “o” are 60 ms, 60 ms, 65 ms, 80 ms, and 105 ms, respectively, no significant difference occurs; on the other hand, at 3× speed, since the phoneme length of the phoneme “sh” is 59 ms while the phoneme lengths of the other phonemes “i”, “n”, “y”, “o”, and “o” are 20 ms, 20 ms, 22 ms, 27 ms, and 35 ms, respectively, a significant difference occurs. As a result, the listenability can be improved, so that the recognizability is improved.

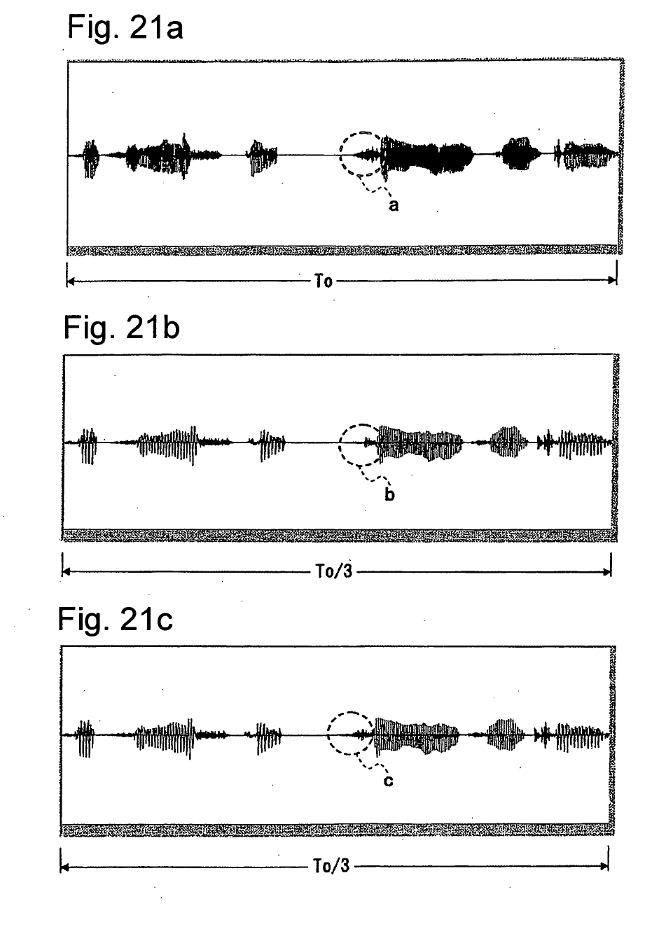

Regarding synthesized speech waveforms as the result of processing, FIGS. 21A, 21B, and 21C are referred to. FIG. 21a shows synthesized speech waveforms in a case where a text “so tsugyoushi te, shinyou kin koni” is read at the normal speech rate. In this case, the text is read in the processing shown in the flowchart in FIG. 17. FIG. 21b shows synthesized speech waveforms in a case where the same text is read at a high speech rate. In this case, the text is read in the processing shown in the flowchart in FIG. 17, i.e., the phoneme length of fricatives is not extended. FIG. 21c shows synthesized speech waveforms in a case where the same text is read at a high speech rate. In this case, the processing (the flowchart shown in FIG. 6) according to the first embodiment is applied, and the phoneme lengths of fricatives are extended. Assuming that time for speech reading in FIG. 21a is To, in FIGS. 21B and 21C, since 3× speed is selected, time for speech reading is To/3.

A part a surrounded by a dotted line in FIG. 21a indicates a fricative, and a part b surrounded by a dotted line in FIG. 21b also indicates the same phoneme. It can be understood that the length of the phoneme in the part b is reduced in response to the speech rate, which is tripled. When the speech sound of such a phoneme is heard, it seems like that a break occurs in the sound, and it is difficult to hear the fricative. On the other hand, in a part c surrounded by a doted line in FIG. 21c, the phoneme length of the fricative is extended in response to a speech rate of 3×. Thus, even when the speech sound of such a phoneme is heard at a high speech rate, no break occurs in the sound, and the listenability can be improved.

### Second Example

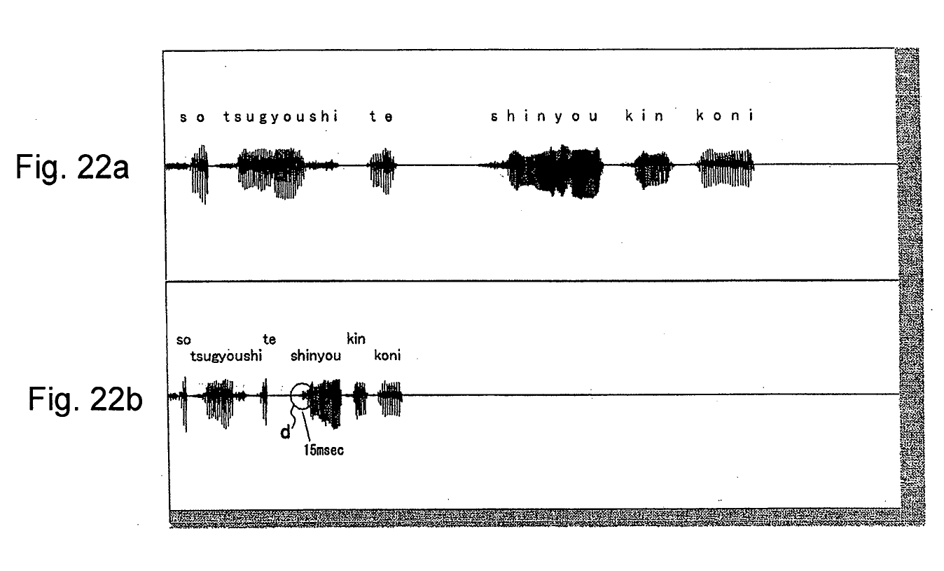

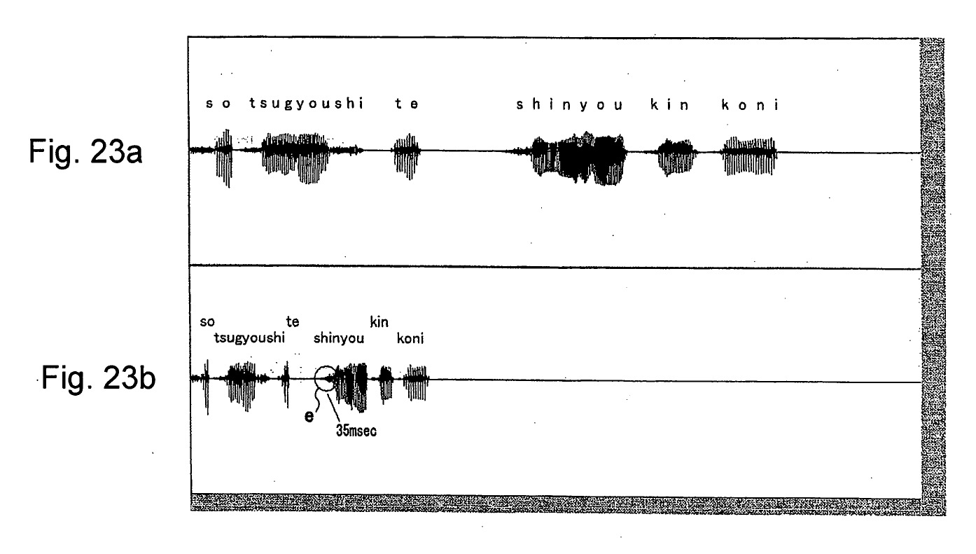

Regarding synthesized speech waveforms that represent the result of processing in a second example, FIGS. 22 and 23 are referred to. FIG. 22 shows synthesized speech waveforms in a comparative example. FIG. 23 shows synthesized speech waveforms in the second example. FIG. 22a shows waveforms at the normal speech rate, and FIG. 22b shows waveforms at a high speech rate. In the case of speech reading at a high speech rate shown in Part B, the phoneme length of a fricative in a part d is shortened so as to vary inversely as the speech rate. In this example, the phoneme length of the fricative is shortened to 15 ms.

On the other hand, FIG. 23a shows waveforms at the normal speech rate in the processing (the flowchart in FIG. 6) according to the first embodiment, and Part B shows waveforms in a case where the phoneme length of a fricative is extended in response to a high speech rate.

Comparing the part d in FIG. 22b with a part e in FIG. 23b shows that, when a phoneme length derived on the basis of a simple inverse relationship is extended, the phoneme length is extended to 35 ms, i.e., the phoneme length is multiplied by about 2.3. Thus, no break occurs in the sound, and the listenability is improved.

### Third Example

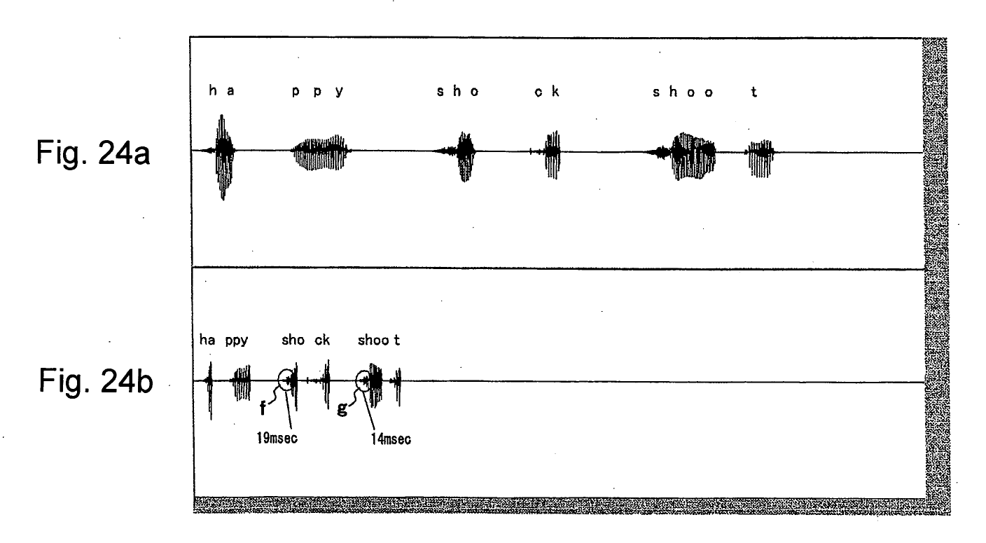

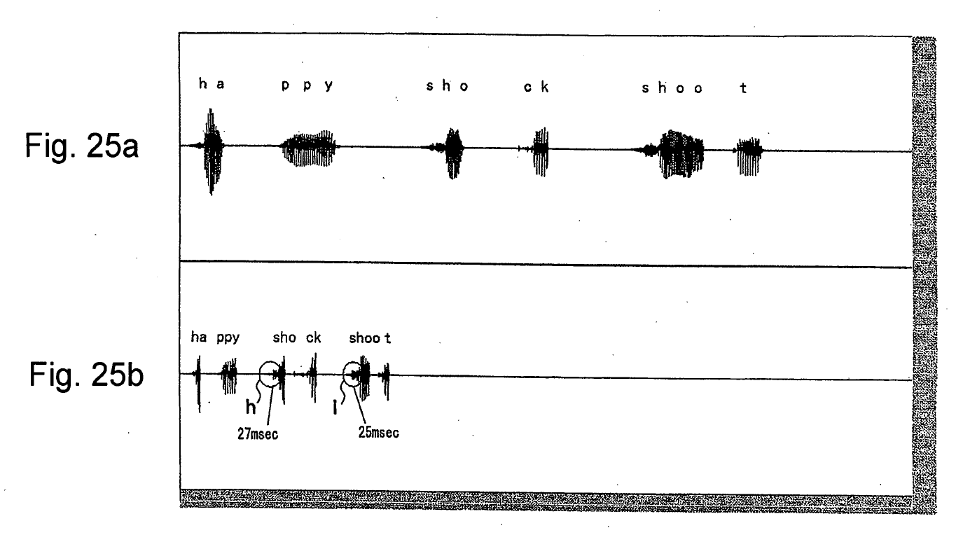

Regarding synthesized speech waveforms that represent the result of processing in a third example, FIGS. 24 and 25 are referred to. FIG. 24 shows synthesized speech waveforms in a comparative example. FIG. 25 shows synthesized speech waveforms in the third example. While a Japanese text is read in the first and second examples, an English text “ha ppy, sho ck, shoo t” is read in the third example.

FIG. 24a shows waveforms at the normal speech rate, and Part B shows waveforms at a high speech rate. In the case of speech reading at a high speech rate shown in Part B, the phoneme lengths of fricatives in parts f and g are shortened so as to vary inversely as the speech rate. In this example, the phoneme length of the fricative in the part f is shortened to 19 ms, and the phoneme length of the fricative in the part g is shortened to 14 ms.

On the other hand, FIG. 25a shows waveforms at the normal speech rate in the processing (the flowchart in FIG. 6) according to the first embodiment, and Part B shows waveforms in a case where the phoneme lengths of fricatives are extended in response to a high speech rate.

Comparing the parts f and g in FIG. 24b with parts h and in FIG. 25b shows that, when phoneme lengths derived on the basis of a simple inverse relationship are extended, the phoneme length is extended to 27 ms in the part h, and the phoneme length is extended to 25 ms in the part i, i.e., the phoneme lengths are substantially doubled. Thus, no break occurs in the sound, and the listenability is improved.

Technical ideas extracted from the aforementioned embodiments of the present invention will now be described.

What is claimed is:

1. An apparatus for converting text data into sound signal, comprising:
a phoneme determiner for determining phoneme data corresponding to a plurality of phonemes and pause data corresponding to a plurality of pauses to be inserted among a series of phonemes in the text data to be converted into sound signal;
a phoneme length adjuster for modifying the phoneme data and the pause data by determining lengths of the phonemes, respectively in accordance with a speed of the sound signal and selectively adjusting the length of at least one of the phonemes which is a fricative in the text data so that the at least one of the fricative phonemes is relatively extended timewise as compared to other phonemes; and
an output unit for outputting sound signal on the basis of the adjusted phoneme data and pause data by the phoneme length adjuster.

2. The apparatus according to claim 1, further comprising:
a speed determiner for determining a speed of the sound signal;
wherein when the speed determiner determines that the speed of the sound signal is higher than predetermined speed, the phoneme length adjuster modifies the phoneme data by increasing the length of the fricative phoneme.

3. The apparatus according to claim 1, further comprising:
a breath-group calculator for calculating a length of a breath group,
wherein the phoneme length adjuster modifies the phoneme data and pause data by increasing or reducing proportionally phoneme lengths and pause lengths in the breath group in accordance with the length of the breath group.

4. The apparatus according to claim 1, further comprising:
a sentence calculator for calculating a length of a read-aloud sentence of the text data,
wherein the phoneme length adjuster proportionally modifies the phoneme data and pause data by increasing or reducing proportionally phoneme lengths and pause lengths in the sentence in accordance with the length of the read-aloud sentence of the text data.

5. The apparatus according to claim 1, wherein when the speed of the sound signal is higher than predetermined speed, the phoneme length adjuster modifies the pause data by reducing a pause length in the text data to a pause length which is less than the pause length corresponding to the peed of the sound signal.

6. The apparatus according to claim 1, wherein when the speed of the sound signal is higher than predetermined speed, the phoneme length adjuster modifies the pause data by removing at last one pause in the text data.

7. The apparatus according to claim 1, wherein the phoneme length adjuster modifies the phoneme data and the pause data by reducing other phoneme lengths and other pause lengths so as to correspond to an increase in the phoneme length.

8. A method for converting text data into sound signal, comprising the steps of:
determining phoneme data corresponding to a plurality of phonemes and pause data corresponding to a plurality of pauses to be inserted among a series of phonemes in the text data to be converted into sound signal;
modifying the phoneme data and the pause data by determining lengths of the phonemes, respectively in accordance with a speed of the sound signal and selectively adjusting the length of at least one of the phonemes which is a fricative in the text data so that the at least one of the fricative phonemes is relatively extended timewise as compared to other phonemes; and
outputting sound signal on the basis of the adjusted phoneme data and pause data.

9. The method according to claim 8, further comprising the steps of:
determining a speed of the sound signal; and
modifying the phoneme data by increasing the length of the fricative phoneme when the speed of the sound signal is higher than predetermined speed.

10. The method according to claim 8, further comprising the steps of:
calculating a length of a breath group; and
modifying the phoneme data by increasing or reducing proportionally phoneme lengths in the breath group in accordance with the length of the breath group.

11. The method according to claim 8, further comprising the steps of:
calculating a length of a read-aloud sentence of the text data; and
modifying the phoneme data by increasing or reducing proportionally phoneme lengths in the sentence in accordance with the length of the read-aloud sentence of the text data.

12. The method according to claim 8, further comprising the steps of:
modifying the pause data by reducing a pause length in the text data to a pause length which is less than the pause length corresponding to the speed of the sound signal, when the speed of the sound signal is higher than predetermined speed.

13. The method according to claim 8, further comprising the steps of:
modifying the pause data by removing at last one pause in the text data, when the speed of the sound signal is higher than predetermined speed.

14. The method according to claim 8, further comprising the steps of:
modifying the phoneme data and the pause data by reducing other phoneme lengths and pause lengths so as to correspond to an increase in the fricative length.

15. An apparatus for converting text data into sound signal, comprising:
a processor for performing a process of converting the text data into sound signal comprising the steps of:
determining data corresponding to a plurality of phoneme types in the text data to be converted into sound signal;
determining phoneme data corresponding to a plurality of phonemes and pause data corresponding to a plurality of pauses to be inserted among a series of phonemes in the text data to be converted into sound signal;
modifying the phoneme data and the pause data by determining lengths of the phonemes, respectively in accordance with a speed of the sound signal and selectively adjusting the length of at least one of the phonemes which is a fricative in the text data so that the at least one of the fricative phonemes is relatively extended timewise as compared to other phonemes; and
an output unit for outputting sound signal on the basis of the adjusted phoneme data and pause data.
